(19) United States
(12) Patent Application Publication
(10) Pub. No.: US 2024/0422674 A1
(43) Pub. Date: Dec. 19, 2024

(54) Enhanced Multi-Link Power Save Mode

(71) Applicant: Ofinno, LLC, Reston, VA (US)

(72) Inventors: Kiseon Ryu, McLean, VA (US); Jeongki Kim, Fairfax, VA (US); Esmael Hejazi Dinan, McLean, VA (US)

(73) Assignee: Ofinno, LLC, Reston, VA (US)

(21) Appl. No.: 18/735,329

(22) Filed: Jun. 6, 2024

Related U.S. Application Data
(63) Continuation of application No. PCT/US2022/052761, filed on Dec. 14, 2022.
(60) Provisional application No. 63/289,825, filed on Dec. 15, 2021.

(51) Int. Cl. H04W 52/02

(52) U.S. Cl. CPC H04W 52/0229

(57) ABSTRACT

A non-access point multi-link device (non-AP MLD) receives from an access point multi-link device (AP MLD), while in a first power save mode, a beacon frame comprising a traffic indication map (TIM) element indicating downlink buffered units (BUs) for the non-AP MLD, where during the first power save mode the non-AP MLD wakes to listen for beacon frames on one of enabled links at least once within a listen interval. After receiving the downlink BUs from the AP MLD, the non-AP MLD switches to a second power save mode, where during the second power save mode the non-AP MLD wakes to listen for beacon frames at each target beacon transmission time (TBTT) on the enabled links until a timer expires.

### CROSS-REFERENCE TO RELATED APPLICATIONS

This application is a continuation of International Application No. PCT/US2022/052761, filed Dec. 14, 2022, which claims the benefit of U.S. Provisional Application No. 63/289,825, filed Dec. 15, 2021, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of target wake time (TWT) operation.

FIG. 4 illustrates an example of TWT operation in an environment including an AP multi-link device (AP MLD) and a station multi-link device (STA MLD).

FIG. 5 illustrates an example TWT element which may be used to support individual TWT operation.

FIG. 6 illustrates an example TWT element which may be used to support restricted TWT (r-TWT) operation.

FIG. 7 illustrates an example of individual TWT operation.

FIG. 8 illustrates an example of broadcast TWT operation.

FIG. 9 illustrates an example of TWT protection in individual TWT operation.

FIG. 10 illustrates an example of restricted TWT (r-TWT) operation.

FIG. 11 illustrates an example of power save mode operation of a STA.

FIG. 12 illustrates an example of listening for beacon frames by a STA in power save mode.

FIG. 13 illustrates an example of traffic indication map element construction by an AP.

FIG. 14 is an example that illustrates the power save operation of a STA affiliated with a non-AP MLD during multi-link operation.

FIG. 15 illustrates an example of multi-link traffic element construction by an AP.

FIG. 16 illustrates an example of listening for beacon frames over multi-link by a non-AP MLD in power save mode.

FIG. 17 is an example that illustrates a problem that may arise using an existing method for listening for beacon frames during a multi-link power save mode.

FIG. 18 is an example that illustrates an example operation of a multi-link power save mode according to an embodiment.

FIG. 19 is an example that illustrates another example operation of a multi-link power save mode according to an embodiment.

FIG. 20 is an example that illustrates another example operation of a multi-link power save mode according to an embodiment.

FIG. 21 is an example that illustrates another example operation of a multi-link power save mode according to an embodiment.

FIG. 22 illustrates an example process according to an embodiment.

FIG. 23 illustrates another example process according to an embodiment.

FIG. 24 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

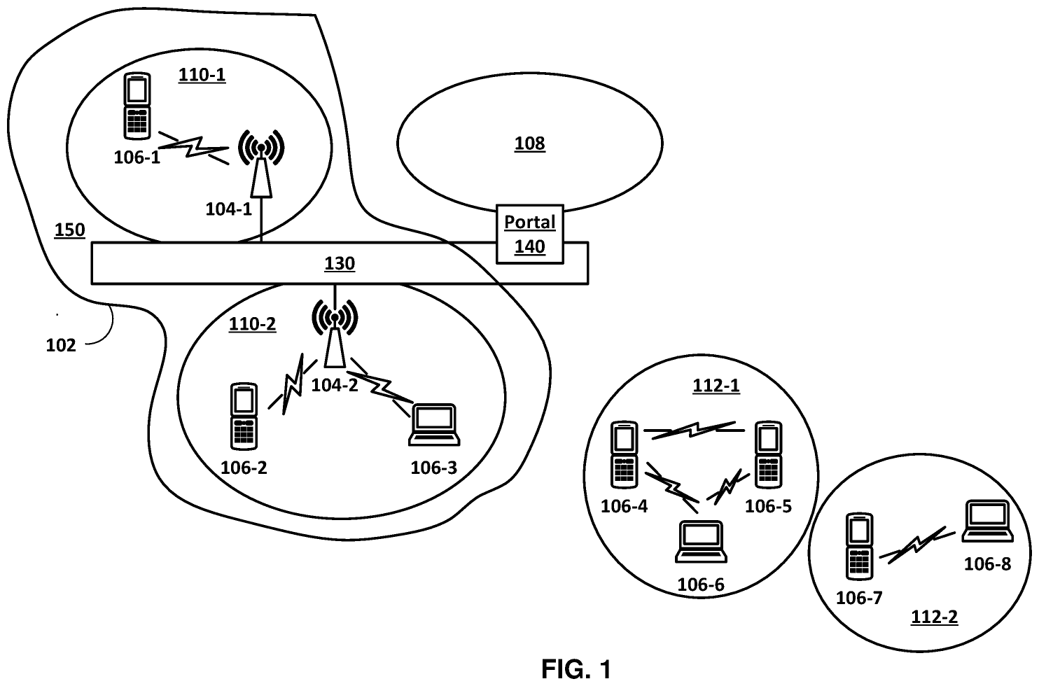

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHZ, 5 GHZ, and/or 6 GHz bands, each of which may be divided into multiple 20 MHz channels. The PPDUs may be transmitted over a physical channel having a minimum bandwidth of 20 MHZ. Larger channels may be formed through channel bonding. For example, PPDUs may be transmitted over physical channels having bandwidths of 40 MHZ, 80 MHZ, 160 MHz, or 320 MHz by bonding together multiple 20 MHz channels.

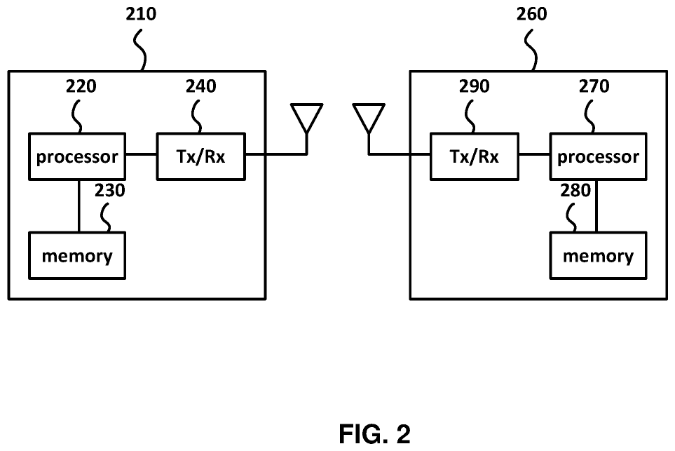

FIG. 2 is a block diagram illustrating example implementations of a STA 210 and an AP 260.

As shown in FIG. 2, STA 210 may include at least one processor 220, a memory 230, and at least one transceiver 240. AP 260 may include at least one processor 270, memory 280, and at least one transceiver 290. Processor 220/270 may be operatively connected to transceiver 240/290.

Transceiver 240/290 may be configured to transmit/receive radio signals. In an embodiment, transceiver 240/290 may implement a PHY layer of the corresponding device (STA 210 or AP 260).

In an embodiment, STA 210 and/or AP 260 may be a multi-link device (MLD), that is a device capable of operating over multiple links as defined by the IEEE 802.11be standard amendment. As such, STA 210 and/or AP 260 may each have multiple PHY layers. The multiple PHY layers may be implemented using one or more of transceivers 240/290.

Processor 220/270 may implement functions of the PHY layer, the MAC layer, and/or the logical link control (LLC) layer of the corresponding device (STA 210 or AP 260).

Processor 220/270 and/or transceiver 240/290 may include application specific integrated circuit (ASIC), other chipset, logic circuit and/or data processor. Memory 230/280 may include read-only memory (ROM), random access memory (RAM), flash memory, memory card, storage medium and/or other storage unit.

When the embodiments are executed by software, the techniques (or methods) described herein can be executed with modules (e.g., processes, functions, and so on) that perform the functions described herein. The modules can be stored in memory 230/280 and executed by processor 220/270. Memory 230/280 may be implemented (or positioned) within processor 220/270 or external to processor 220/270. Memory 230/280 may be operatively connected to processor 220/270 via various means known in the art.

Target wake time (TWT), a feature introduced in the IEEE 802.11ah standard, allows STAs to manage activity in the BSS by scheduling STAs to operate at different times to reduce contention. TWTs may allow STAs to reduce the required amount of time that a STA utilizing a power management mode may be awake. TWTs may be individual TWTs or broadcast TWTs. Individual TWTs follow a negotiated TWT agreement between STAs. Broadcast TWTs are based on a schedule set and provided to STAs by an AP.

In an individual TWT, a STA that requests a TWT agreement is called a TWT requesting STA. The TWT requesting STA may be a non-AP STA for example. The STA that responds to the request is called a TWT responding STA. The TWT responding STA may be an AP for example. The TWT requesting STA is assigned specific times to wake up and exchange frames with the TWT responding STA. The TWT requesting STA may communicate wake scheduling information to the TWT responding STA. The TWT responding STA may transmit TWT values to the TWT requesting STA when a TWT agreement is established between them.

When explicit TWT is employed, the TWT requesting STA may wake up and perform a frame exchange. The TWT requesting STA may receive a next TWT information in a response from the TWT responding STA. When implicit TWT is used, the TWT requesting STA may calculate a next TWT by adding a fixed value to the current TWT value.

The TWT values for implicit TWT may be periodic. The TWT requesting STA operating with an implicit TWT agreement may determine a next TWT service period (TWT SP) start time by adding a value of a TWT wake interval associated with the TWT agreement to the value of the start time of the current TWT SP. The TWT responding STA may include the start time for a series of TWT SPs corresponding to a single TWT flow identifier of an implicit TWT agreement in a target wake time field of a TWT element. The TWT element may contain a value of ‘accept TWT’ in a TWT setup command field. The start time of the TWT SP series may indicate the start time of a first TWT SP in the series. Start times of subsequent TWT SPs may be determined by adding the value of the TWT wake interval to the start time of the current TWT SP. In an example, the TWT requesting STA, awake for an implicit TWT SP, may enter a doze state after the TWT SP has elapsed or after receiving an end of service period (EOSP) field equal to 1 from the TWT responding STA, whichever occurs first.

A TWT session may be negotiated between an AP and a STA. The TWT session may configure a TWT SP of DL and UL traffic between the AP and the STA. Expected traffic may be limited within the negotiated SP. The TWT SP may start at a specific time. The TWT SP may run for a SP duration. The TWT SP may repeat every SP interval.

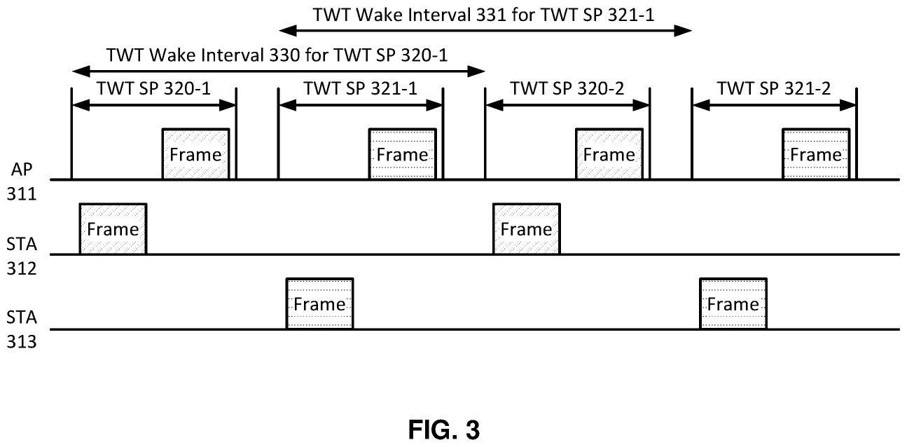

FIG. 3 illustrates an example 300 of TWT operation. As shown in FIG. 3, example 300 includes an AP 311, a STA 312, and a STA 313. AP 311 and STA 312 may establish a TWT SP 320. AP 311 and STA 313 may establish a TWT SP 321. TWT SP 320 and TWT SP 321 may repeat as shown in FIG. 3, such that TWT SP 320 may include a first TWT SP 320-1 and a second TWT SP 320-2, and such that TWT SP 321 may include a first TWT SP 321-1 and a second TWT SP 321-2.

AP 311 and STA 312 may exchange frames during first TWT SP 320-1. STA 312 may enter a doze state at the end of TWT SP 320-1 and may remain in the doze state until the start of second TWT SP 320-2. The start of second TWT SP 320-2 may be indicated by a TWT wake interval 330 associated with TWT SP 320. AP 311 and STA 312 may again exchange frames during second TWT SP 320-2.

Similarly, AP 311 and STA 313 may exchange frames during first TWT SP 321-1. STA 313 may enter a doze state at the end of first TWT SP 321-1 and may remain in the doze state until the start of second TWT SP 321-2. The start of second TWT SP 321-2 may be indicated by a TWT wake interval 331 associated with TWT SP 321. AP 311 and STA 313 may again exchange frames during second TWT SP 31-2.

In an awake state, a STA may be fully powered. The STA may transmit and/or receive a frame to/from an AP or another STA. In a doze state, a STA may not transmit and may not receive a frame to/from an AP or another STA.

An MLD is an entity capable of managing communication over multiple links. The MLD may be a logical entity and may have more than one affiliated station (STA). The MLD may have a single MAC service access point (MAC-SAP) to the LLC layer, which includes a MAC data service. An MLD may be an access point MLD (AP MLD) when a STA affiliated with the MLD is an AP STA (or an AP). An MLD may be a non-access point MLD (non-AP MLD) or STA MLD when a STA affiliated with the MLD is a non-AP STA (or a STA).

During negotiation of TWT agreements, a TWT requesting STA affiliated with a STA MLD and a TWT responding STA affiliated with an AP MLD may communicate multiple TWT elements. The TWT elements may comprise link ID bitmap subfields indicating different link(s) in a TWT setup frame. The TWT parameters provided by a TWT element may be applied to the respective link that is indicated in the TWT element.

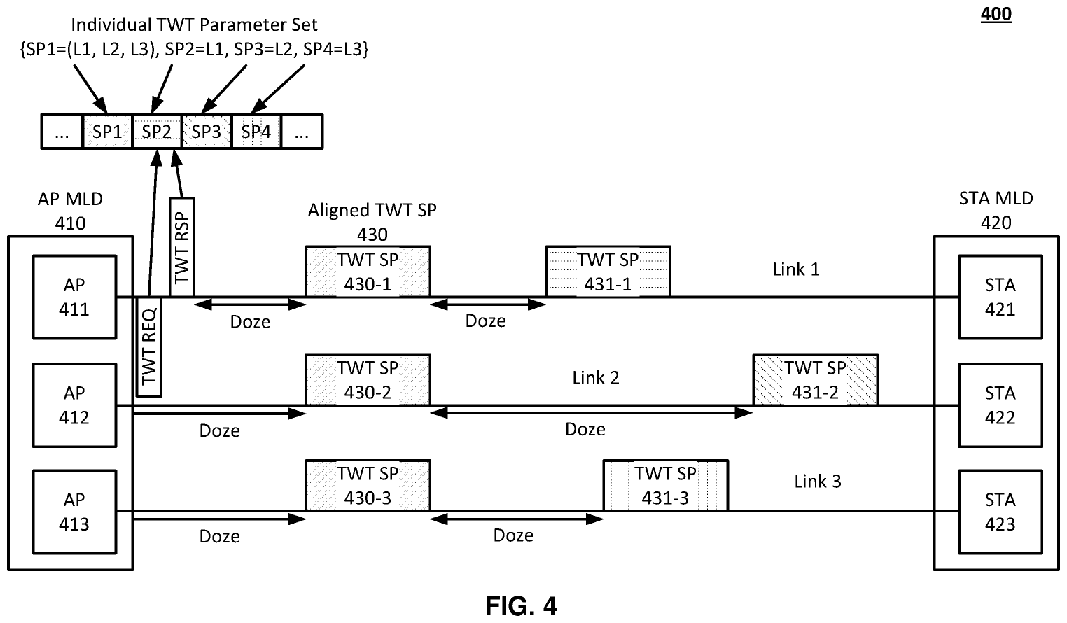

FIG. 4 illustrates an example 400 of TWT operation in a multi-link environment including an AP multi-link device (AP MLD) 410 and a STA multi-link device (STA MLD) 420. As shown in FIG. 4, AP MLD 410 may have three affiliated APs, AP 411, AP2 412, and AP3 413. In an example, AP 411, AP2 412, and AP3 413 may operate respectively on the 2.4 GHz band, the 5 GHz band, and the 6 GHz band. STA MLD 420 may have three affiliated STAs, STA 421, STA 422, and STA 423. In an example, STA 421, STA 422, and STA 423 may operate respectively on the 2.4 GHz band, the 5 GHz band, and the 6 GHz band. In an example, AP 411, AP2 412, and AP3 413 may be communicatively coupled via a first link (link 1), a second link (link 2), and a third link (link 3) respectively with STA 421, STA 422, and STA 423, respectively.

In an example, STA 421 may transmit a TWT request to AP 411. The TWT request may include three TWT elements. Each TWT element may indicate a respective link of links 1-3 and may request the setup of a TWT agreement for the indicated link. The three TWT elements may have different TWT parameters, such as target wake time (TWT). In response to the TWT request, AP 411 may transmit a TWT response to STA 421. The TWT response may include three TWT elements. Each TWT element may indicate a respective link of links 1-3 and may include a value of ‘accept TWT’ in a TWT setup command field.

Successful TWT agreement setup on links 1-3 establishes three TWT SPs with same or different TWT parameters on links 1-3 respectively. The target wake time field of the TWT element indicating a given link indicates the start time of the TWP SP for that link. The starting time may be indicated in reference to a time synchronization function (TSF) time of the link.

In example 400, initial TWT SPs 430-1, 430-2, and 430-3 of links 1-3 respectively may be aligned. TWT wake intervals associated with the TWT agreements of links 1-3 respectively may be set differently. As such, second TWT SPs 431-1, 431-2, and 431-3 of links 1-3 respectively may not be aligned. STA 421, STA 422, and STA 423 may enter a doze state between the end of initial TWT SPs 430-1, 430-2, and 430-3, respectively, and the start of second TWT SPs 431-1, 431-2, 431-3, respectively.

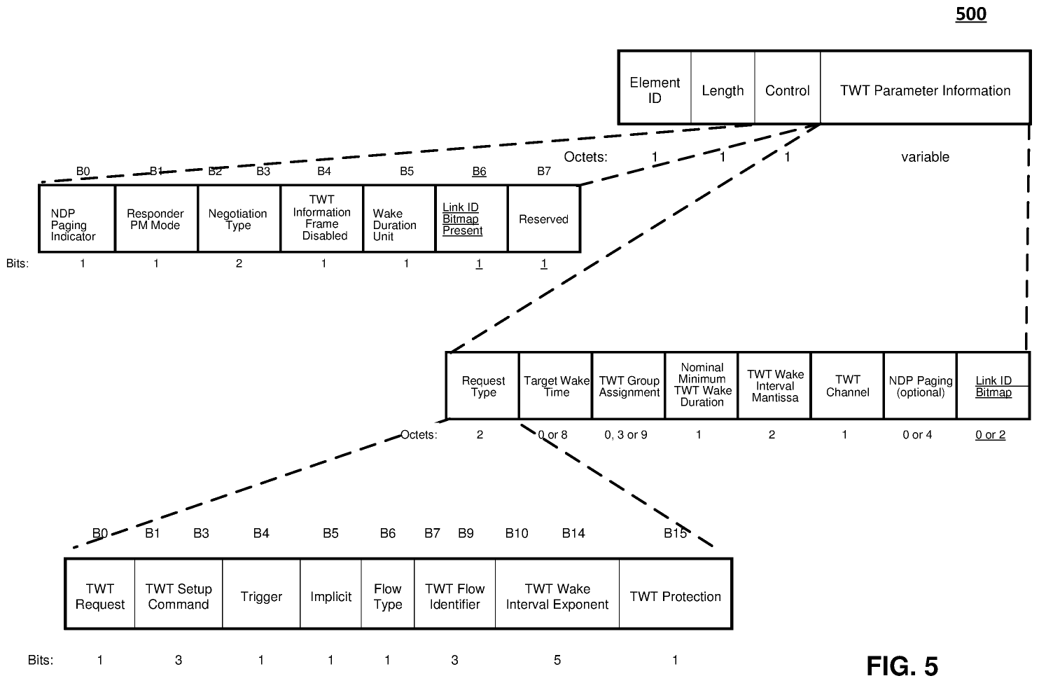

FIG. 5 illustrates an example target wake time (TWT) element 500 which may be used to support individual TWT operation.

In an example, an AP and a STA may use TWT element 500 to negotiate a TWT agreement. The AP and/or the STA may transmit TWT element 500 in an individually addressed management frame. The management frame may be of the type action, action no ack, (re) association request/response, and probe request response, for example.

The TWT schedule and parameters may be provided during a TWT setup phase. Renegotiation/changes of TWT schedules may be signaled via individually addressed frames that contain the updated TWT schedule/parameters. The frames may be management frames as described above or control or data frames that carry a field containing the updated TWT schedule/parameters.

Referring to FIG. 5, TWT element 500 includes an element ID field, a length field, a control field, and a TWT parameter information field.

The element ID field (e.g., 1 octet in length) may indicate that information element 500 is a TWT element. The length field (e.g., 1 octet) may indicate the length of TWT element 500 starting from the control field until an end of TWT element 500. The end of TWT element 500 may be the end of a TWT Channel field or the end of a Link ID bitmap field of the TWT parameter information field.

The TWT parameter information field may include a request type field (e.g., 2 octets), a target wake time field (e.g., 8 octets or less), a TWT group assignment field (e.g., 9, 3, 2, or 0 octets), a nominal minimal TWT wake duration field (e.g., 1 octet), a TWT wake interval mantissa (e.g., 2 octets), a TWT channel field (e.g., 1 octet), an optional NDP paging field (e.g., 0 or 4 octets), and/or a Link ID bitmaps field (e.g., 0 or 2 Octets).

The request type field may indicate a type of TWT request. The request type field may include a TWT request field (e.g., 1 bit), a TWT setup command field (e.g., 3 bits), a trigger field (e.g., 1 bit), an implicit field (e.g., 1 bit), a flow type (e.g., 1 bit), a TWT flow identifier (e.g., 3 bits), a TWT wake interval exponent (e.g., 5 bits), and/or a TWT protection field (e.g., 1 bit).

The TWT request field may indicate whether the TWT element 500 represents a request. If TWT request field has a value of 1, then the TWT element 500 may represent a request to initiate TWT scheduling/setup.

The TWT setup command field may indicate a type of TWT command. In a TWT request, the type of TWT command indicated may be: a request TWT (the TWT responding STA specifies the TWT value; e.g., field set to 0), a suggest TWT (the TWT requesting STA suggests a TWT value; e.g., field set to 1), and a demand TWT (the TWT requesting STA demands a TWT value; e.g., field set to 2).

In a TWT response, the type of TWT command indicated may be: TWT grouping (the TWT responding STA suggests TWT group parameters that are different than the suggested or demanded TWT parameters of the TWT requesting STA; e.g., field set to 3), accept TWT (the TWT responding STA accepts the TWT request with the TWT parameters indicated by the TWT requesting STA; e.g. field set to 4), alternate TWT (the TWT responding STA suggests TWT parameters that are different than the parameters suggested or demanded by the TWT requesting STA; e.g., field set to 5), dictate TWT (the TWT responding STA demands TWT parameters that are different than the parameters suggested or demanded by the TWT requesting STA; e.g., field set to 6), or reject TWT (the TWT responding STA rejects the TWT setup; e.g. field set to 7).

In a TWT response, the TWT command may also indicate an unsolicited response or a broadcast TWT. An unsolicited TWT response is an individually addressed frame that is intended for a specific STA. An unsolicited TWT response may be followed by an ACK frame from the STA receiving the unsolicited TWT response. A broadcast TWT may be intended for multiple STAs and may be carried in a broadcast frame such as, for example, a beacon frame. A broadcast TWT may not be acknowledged by receiving STAs.

An unsolicited TWT response may be used a TWT responding STA to demand that a recipient follow a TWT schedule contained in the TWT element. In an embodiment, an unsolicited TWT response may have the TWT request field set to 0 and a value of ‘dictate TWT’ in the TWT setup command field. A broadcast TWT response may be used by a TWT responding STA to schedule a TWT for any STA that receives and decodes the TWT element.

In certain embodiments, a TWT element, such as TWT element 500, may contain TWT parameter sets for multiple TWT negotiations or indications as described herein. As such, the TWT element may include multiple instances of the Control and the TWT parameter information fields. The TWT flow identifier of the request type field indicates the TWT negotiation which parameters are carried by the TWT parameter information field.

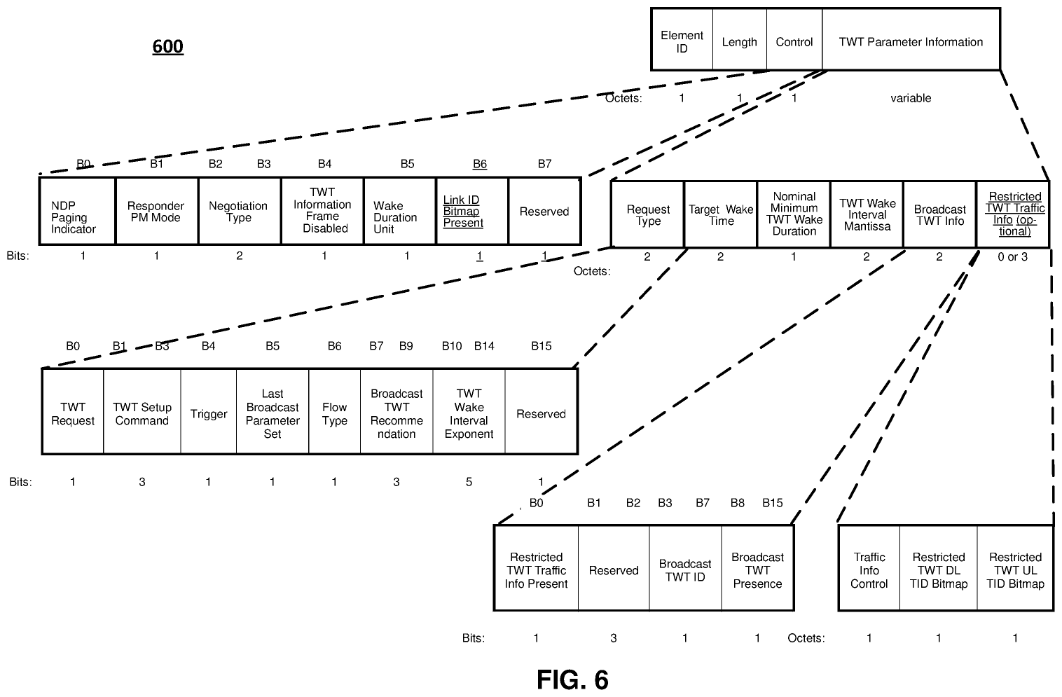

FIG. 6 illustrates an example target wake time (TWT) element 600 which may be used to support restricted TWT (r-TWT) operation. For r-TWT, TWT element 600 may be transmitted in a broadcast management frame, which can be a beacon frame, a TIM broadcast frame, a probe response frame, etc. In this embodiment, TWT element 600 provides non-negotiated TWT schedules (e.g., broadcast TWT schedules).

As shown, TWT element 600 includes an element ID field, a length field, a control field, and a TWT parameter information field.

The element ID field (e.g., 1 octet in length) may indicate that information element 600 is a TWT element. The length field (e.g., 1 octet) may indicate the length of TWT element 600 starting from the control field until an end of TWT element 600. The end of TWT element 600 may be the end of a broadcast TWT info field or the end of a r-TWT traffic info field of the TWT parameter information field.

The TWT parameter information field may include a request type field, a target wake time field (e.g., 2 octets), a nominal minimal TWT wake duration field (e.g., 1 octet), a TWT wake interval mantissa (e.g., 2 octets), a broadcast TWT info field (e.g., 2 octets), and an optional r-TWT traffic info field (e.g., 0 or 3 octets).

The request type field may include, among other fields, a TWT request field, a flow type field, and a TWT wake interval exponent field.

The TWT request field indicates whether TWT element 600 is a request. If the TWT request field has a value of 0, then TWT element 600 may represent a response to a request to initiate TWT scheduling/setup (solicit TWT), an unsolicited TWT response, and/or a broadcast TWT message.

The TWT wake interval represents the average time that a TWT requesting STA or a TWT scheduled STA expects to elapse between successive TWT SP start times of a TWT schedule. The TWT wake interval exponent field indicates a (base 2) exponent used to calculate the TWT wake interval in microseconds. In an embodiment, the TWT wake interval is equal to: (TWT wake interval mantissa)×2^{(TWT Wake Interval Exponent)}. The TWT wake interval mantissa value is indicated in microseconds, base 2 in a TWT wake interval mantissa field of the TWT parameter information field.

The nominal minimum TWT wake duration field may indicate the minimum amount of time (in the unit indicated by a wake duration unit subfield of the control field) that a TWT requesting STA or a TWT scheduled STA is expected to be awake to complete frame exchanges for the period of the TWT wake interval.

The flow type field, in a TWT response that successfully set up a TWT agreement between a TWT requesting STA and a TWT responding STA, may indicate a type of interaction between the TWT requesting STA and the TWT responding STA within a TWT SP of the TWT agreement. A flow type field equal to 0 may indicate an announced TWT. In an announced TWT, the TWT responding STA may not transmit a frame to the TWT requesting STA within a TWT SP until the TWT responding STA receives a PS-Poll frame or a QoS Null frame from the TWT requesting STA. A flow type field equal to 1 may indicate an unannounced TWT. In an unannounced TWT, the TWT responding STA may transmit a frame to the TWT requesting STA within a TWT SP before it has received a frame from the TWT requesting STA.

Within a TWT element that includes a TWT setup command value of ‘request TWT’, ‘suggest TWT’, or ‘demand TWT’, a broadcast TWT ID may indicate a specific broadcast TWT in which the TWT requesting STA is requesting to participate. Within a TWT element that includes a TWT setup command value of ‘accept TWT’, ‘alternate TWT’, ‘dictate TWT’, or ‘reject TWT’, a broadcast TWT ID may indicate a specific broadcast TWT for which the TWT responding STA is providing TWT parameters. The value 0 in the broadcast TWT ID subfield may indicate the broadcast TWT whose membership corresponds to all STAs that are members of the BSS corresponding to the BSSID of the management frame carrying the TWT element and that is permitted to contain trigger frames with random access resource units for unassociated STAs. The Broadcast TWT ID subfield in a r-TWT Parameter set field is always set to a nonzero value.

A broadcast TWT element 600 that contains a r-TWT parameter set is also referred to as a r-TWT element. A r-TWT traffic info present subfield of the broadcast TWT info field may be set to 1 to indicate the presence of the r-TWT traffic info field in TWT element 600. The r-TWT traffic info field is present in a r-TWT parameter set field when the r-TWT traffic info present subfield is set to 1.

The r-TWT traffic info field may include a traffic info control field, a r-TWT DL TID bitmap field, and a r-TWT UL TID bitmap field.

The traffic info control field may include a DL TID bitmap valid subfield and an UL TID bitmap valid subfield. The DL TID bitmap valid subfield indicates if the r-TWT DL TID bitmap field has valid information. When the value of the DL TID bitmap valid subfield is set to 0, it may indicate that DL traffic of TIDs is identified as latency sensitive traffic, and the r-TWT DL TID bitmap field is reserved. The UL TID bitmap valid subfield may indicate if the r-TWT UL TID bitmap field has valid information. When the value of the UL TID bitmap valid subfield is set to 0, it may indicate that UL traffic of TIDs is identified as latency sensitive traffic, and the r-TWT UL TID bitmap field is reserved.

The r-TWT DL TID bitmap subfield and the r-TWT UL TID bitmap subfield may specify which traffic identifier(s) (TID(s) are identified by the TWT scheduling AP or the TWT scheduled STA as latency sensitive traffic streams in a downlink and a uplink direction, respectively. A value of 1 at bit position k in the bitmap indicates that TID k is classified as a latency sensitive traffic stream. A value of 0 at bit position k in the bitmap indicates that TID k is not classified as a latency sensitive traffic stream.

An individual target wake time (TWT) may be a specific time or set of times negotiated between two individual stations (e.g., a STA and another STA, or a STA and an AP, etc.) at which the stations may be awake to exchange frames during a service period (SP) of the TWT.

In trigger-enabled TWT, an AP may transmit a trigger frame for scheduling uplink multi-user transmissions from one or more STAs using uplink OFDMA (orthogonal frequency division multiple access) and/or uplink MU-MIMO (multi-user multiple input multiple output) during a trigger-enabled (TE) TWT SP. A TWT STA that receives the trigger frame from the AP may transmit a frame to the AP through a resource indicated in the trigger frame during the TE TWT SP.

In non-trigger-enabled TWT, an AP may not be required to transmit a trigger frame to schedule uplink multi-user transmissions from one or more STAs during a non-trigger-enabled TWT SP.

In announced TWT, a STA may transmit a frame (e.g., a PS-Poll frame or a QoS null frame) to the AP to retrieve a downlink buffered data from the AP during a TWT SP. In unannounced TWT, an AP may transmit downlink data to a TWT STA without receiving a frame (e.g., a PS-Poll frame, or a QoS null frame) from the TWT STA during a TWT SP.

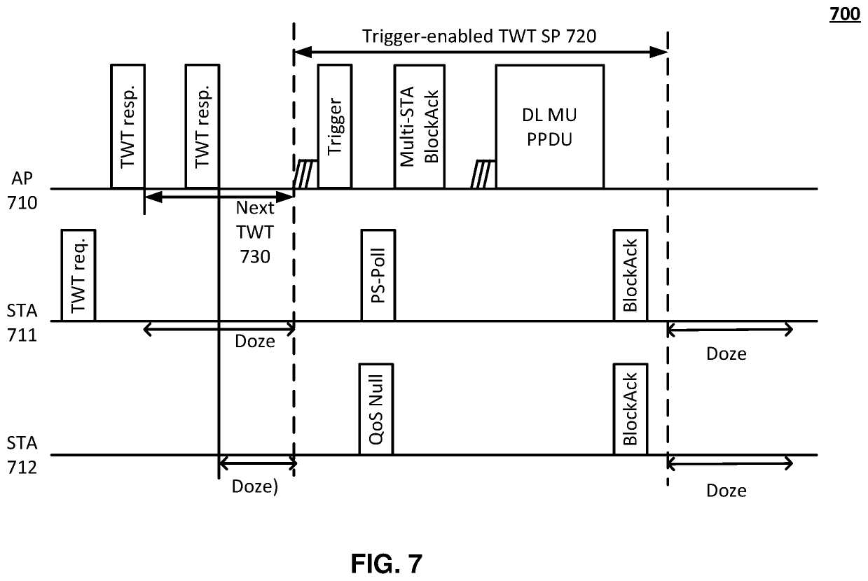

FIG. 7 illustrates an example 700 of individual TWT operation. As shown in FIG. 7, example 700 includes an AP 710, a STA 711, and a STA 712. In an example, AP 710 may be a TWT responding STA and STA 711 and STA 712 may be TWT requesting STAs.

In an example, STA 711 may transmit a TWT request to AP 710 to setup a first trigger-enabled TWT agreement. STA 711 may set a trigger field of the TWT request to 1 to indicate that it is requesting a trigger-enabled TWT. AP 710 may accept the first TWT agreement with STA 711. AP 710 may confirm the acceptance in a TWT response sent to STA 711. The TWT response may indicate a next TWT 730, which indicates the time until a next TWT SP 720 according to the first TWT agreement.

In an example, AP 710 may transmit an unsolicited TWT response to STA 712 to set up a second trigger-enabled TWT agreement with STA 712 without receiving a TWT request from STA 712. The first and second TWT agreements may be set up as announced TWTs.

After the setup of the TWT agreements, STA 711 and STA 712 may enter a doze state until the start of TWT SP 720. During TE TWT SP 720, AP 710 may transmit a trigger frame. STA 711 and STA 12 may respond to the trigger frame by indicating that they are in awake state. In an example, STA 711 may transmit a power save poll (PS-Poll) frame. The PS-Poll frame may comprise a BSSID (receiver address: RA) field set to an address of AP 710 and a transmitter address (TA) field set to an address of STA 711. In an example, STA 712 may transmit a QoS null frame in response to the trigger frame. The QoS null frame may comprise a MAC header (e.g., a frame control field, a duration field, address fields, a sequence control field, QoS control field) without a frame body.

In response to the PS-Poll frame and the QoS null frame, AP 710 may transmit a multi-STA Block Ack (M-BA) frame. The M-BA frame may include acknowledgement information associated with the PS-Poll frame and the QoS null frame received from STAs 711 and 712 respectively. Subsequently, STA 711 and STA 712 may receive downlink bufferable units (DL BUs) from AP 710. The DL BUs may include a medium access control (MAC) service data unit (MSDU), an aggregate MAC service data unit (A-MSDU), and/or a bufferable MAC management protocol data unit (MMPDU). STA 711 and STA 712 may transmit Block Ack (BA) frames in response to the DL BUs. At the end of the TWT SP 720, STA 711 and STA 712 may return to a doze state.

A STA may execute individual TWT setup exchanges. The STA may not transmit frames to an AP outside of negotiated TWT SPs. The STA may not transmit frames that are not contained within high efficiency trigger-based physical protocol data units (HE TB PPDUs) to the AP within TE TWT SPs. A HE TB PPDU may be transmitted by a STA based on receiving a trigger frame triggering uplink multi-user transmissions.

The AP of a trigger-enabled TWT agreement may schedule for transmission a trigger frame for a STA within the TE TWT SP. The STA may transmit an HE TB PPDU as a response to the trigger frame sent during the TE TWT SP. A STA that is in power save (PS) mode may include a PS-Poll frame or a QoS null frame in the HE TB PPDU if the TWT is an announced TWT, to indicate to the AP that the STA is currently in the awake state. The AP that receives the PS-Poll frame or the QoS Null frame or any other indication from a STA in PS mode, may deliver to the STA as many buffered BUs as are available at the AP during the TWT SP.

A broadcast target wake time (TWT) may be a specific time or set of times broadcast by an AP to one or more STAs at which the STAs may be awake to exchange frames with the AP during a SP of the TWT.

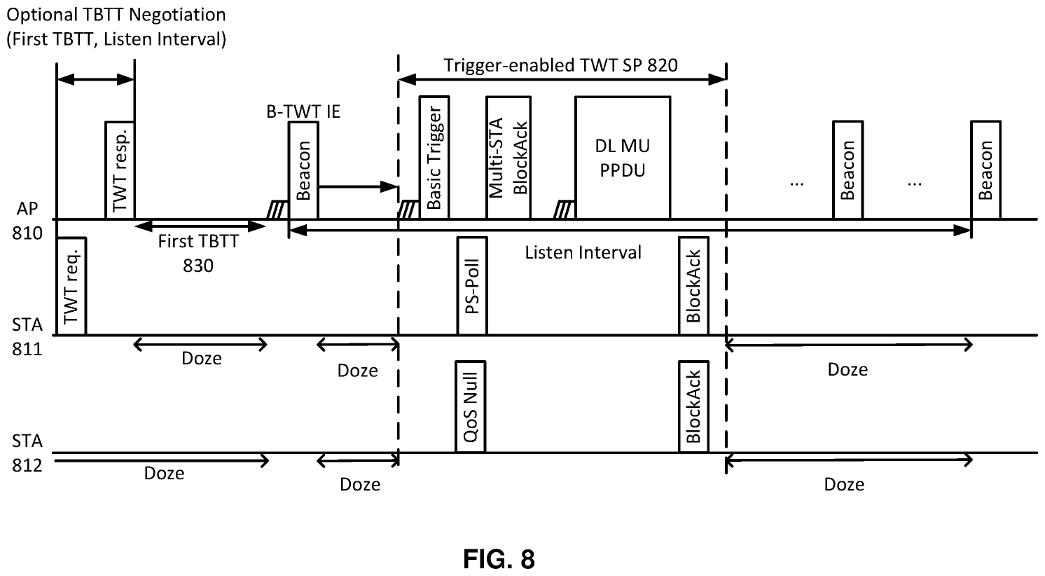

FIG. 8 illustrates an example 800 of broadcast TWT operation. As shown in FIG. 8, example 800 includes an AP 810, a STA 811, and a STA 812. In an example 800, AP 810 may be a TWT scheduling AP and STA 811 and STA 812 may be TWT scheduled STAs.

In an example, AP 810 may include a broadcast TWT element in a beacon frame that indicates a broadcast TWT SP 820. During the broadcast TWT SP 820, AP 810 may transmit trigger frames or DL BUs to STA 811 and STA 812. Beacon frames may be sent by AP 810 at a regular interval defined as the target beacon transmission time (TBTT). The TBTT is a time interval measured in time units (TUs). A TU is equal to 1024 microseconds.

In an example, STA 811 and STA 812 may enter a doze state until the first target beacon transmission time (TBTT). STA 811 and STA 812 may wake up to receive the beacon frame at the first TBTT to determine the broadcast TWT. Upon reception of a broadcast TWT element in a beacon frame, STA 811 and STA 812 may re-enter the doze state until the start of TE TWT SP 820.

During TE TWT SP 820, AP 810 may transmit a basic trigger frame to STA 811 and STA 812. STA 811 may indicate that it is awake by transmitting a PS-Poll, and STA 812 may indicate that it is awake by transmitting a QoS null frame in response to the basic trigger frame. Subsequently, STA 811 and STA 812 may receive DL BUs from AP 810. STA 811 and STA 812 may return to the doze state outside of the TWT SP 720.

In an example, a STA that intends to operate in power save mode may negotiate a wake TBTT and a wake interval with the AP. For example, as shown in FIG. 8, STA 811 may transmit a TWT request to AP 810 that identifies a wake TBTT of the first beacon frame and a wake interval between subsequent beacon frames. AP 810 may respond with a TWT response to the TWT request confirming the wake TBTT and wake interval. After successfully completing the negotiation, STA 811 may enter a doze state until a first negotiated wake TBTT 830. STA 811 may be in an awake state to listen to the beacon frame transmitted at first negotiated wake TBTT 830. If STA 811 receives a beacon frame from AP 810 at or after TBTT 830, STA 811 may return to the doze state until the next wake TBTT unless a traffic indication map (TIM) element in a beacon frame includes a positive indication for STA 811. The STA 811 may return to the doze state after a nominal minimum TBTT wake duration time has elapsed from the TBTT start time.

A Network Allocation Vector (NAV) is an indicator, maintained by a station (STA), of time periods when transmission onto the wireless medium (WM) may not be initiated by the STA regardless of whether the clear channel assessment (CCA) function of the STA senses that the WM is busy. A STA that receives at least one valid frame in a PSDU may update its NAV with the information from any valid duration field in the PSDU. The STA may update the NAV when a value of the received duration field is greater than the current NAV value of the STA.

A TWT protection is a mechanism employed to protect a TWT session from external STA transmissions. During a TWT SP configured to protect the TWT session, a STA that initiates a transmission opportunity (TXOP) to transmit a frame may transmit a request to transmit (RTS) frame or a clear to transmit (CTS) frame to protect the TWT session by setting the NAV of other STAs based on receiving of the RTS frame and/or the CTS frame. The RTS frame may comprise a frame control field, a duration field, a receiver address (RA) field, a transmitter address (TA) field, and a frame check sequence (FCS) field. The CTS frame may comprise a frame control field, a duration field, a receiver address (RA) field, and a frame check sequence (FCS) field.

The TWT protection field in a TWT element may indicate whether a TWT is protected or unprotected. A TWT requesting STA may set the TWT protection field to 1 to request the TWT responding STA to provide protection for the set of TWT SPs. A TWT protection field equal to 1 may indicate to use a NAV protection mechanism to protect access to the medium during the corresponding TWT SPs.

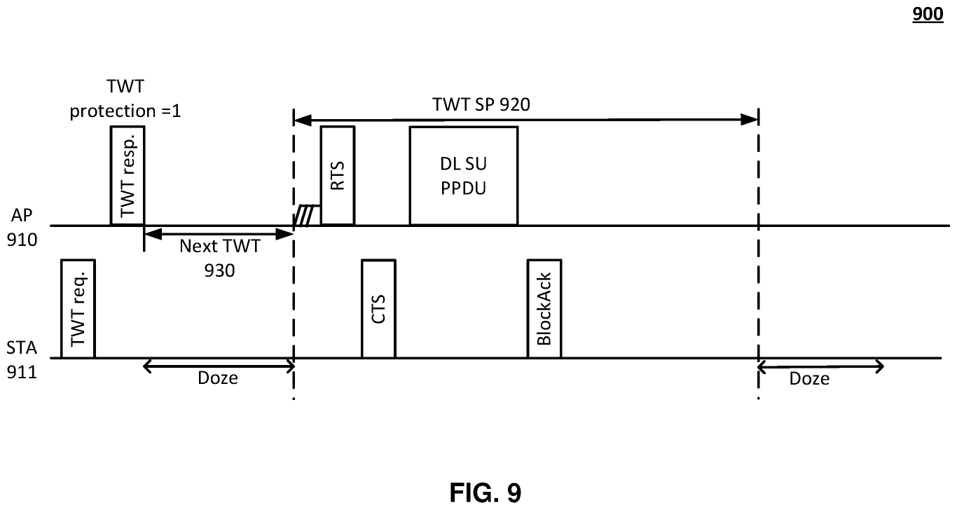

FIG. 9 illustrates an example 900 of TWT protection in individual TWT operation. As shown in FIG. 9, example 900 includes an AP 910 and a STA 911.

In an example, AP 910 may set the TWT protection field to 1 in a TWT response frame to protect the TWT SPs using a NAV protection mechanism. Upon reception of the TWT response frame, STA 911 may enter a doze state until the next TWT 930. AP 910 that has set the TWT protection field to 1 may transmit a NAV setting frame at the start of the TWT SP 920. For example, the NAV setting frame may be an RTS frame or a CTS frame.

A STA that receives the NV setting frame and that is not scheduled to access the medium during the TWT SP 920 may set their NAV according to the NAV setting frame. The STA may not access the medium for the specified amount of time in the NAV setting frame.

STA 911 may be scheduled to access the medium during the TWT SP 920. STA 911 may respond to the RTS frame with a CTS frame. Upon receiving the CTS frame, AP 910 may transmit a downlink frame to STA 911. STA 911 may respond to the downlink frame with a BA frame. When the TWT SP 920 ends, STA 911 may return to the doze state.

Traffic originating from many real time applications may have stringent latency requirements (e.g., very low average latency, worst-case latency on the order of a few to tens of milliseconds, and small jitter). Such traffic is referred to as latency sensitive traffic. Restricted TWT operation may allow an AP to use enhanced medium access protection and resource reservation mechanisms to provide more predictable latency, reduced worst case latency, and/or reduced jitter, with higher reliability for latency sensitive traffic.

Using TWT, a STA may negotiate awake periods with an AP to transmit and receive data packets. The STA may save power the rest of the time as the STA may remain in a doze state. TWT operation may thus lead to low power consumption for the participating STAs. TWT operation may also reduce the contention level and may support a collision-free and deterministic operation when STAs are distributed over different TWT sessions.

Using restricted TWT (r-TWT) operation, an AP may allocate r-TWT SP(s) that may be used for transmission of data frames with latency sensitive traffic by the AP and one or more STAs. Traffic identifiers (TIDs) of latency sensitive traffic may be indicated in a broadcast frame (e.g., beacon frame, probe response frame, etc.) sent by the AP. The TIDs may be indicated in a restricted TWT DL TID bitmap and/or a restricted TWT UL TID bitmap of a restricted TWT traffic info field of a TWT element. A data frame with a TID that is not identified as latency sensitive traffic may not be transmitted during an r-TWT SP.

A restricted TWT scheduling AP, referred to as an r-TWT scheduling AP, may be an extremely high throughput AP (EHT AP) (or a “Beyond EHT” AP) that supports restricted TWT operation. A restricted TWT scheduled STA, referred to as an r-TWT scheduled STA, is a non-AP EHT STA (or a non-AP “Beyond EHT” STA) that supports restricted TWT operation. When a restricted TWT agreement is set up, the EHT AP may announce a restricted TWT SP (r-TWT SP) schedule information in a broadcast TWT element. The broadcast TWT element may be contained in a management frame such as a beacon frame or a probe response frame.

The EHT AP may schedule a quiet interval that overlaps with a restricted TWT SP. The quiet interval may have a duration of 1 TU. The quiet interval may start at the same time as the corresponding r-TWT SP. A quiet interval may be scheduled by including a quiet element in a beacon frame and/or a probe response frame. Legacy STAs may not be permitted to initiate a frame transmission during the quiet interval overlapping with the r-TWT SP.

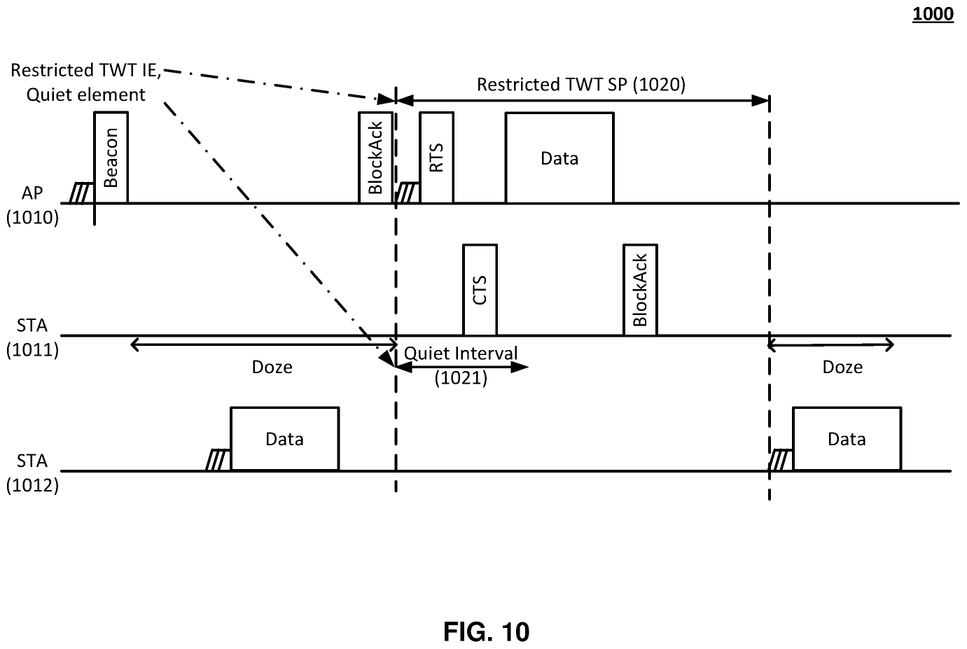

FIG. 10 illustrates an example 1000 of restricted TWT operation. As shown in FIG. 10, example 1000 includes an AP 1010, a first STA 1011, and a second STA 1012.

In an example, a restricted TWT agreement may be setup between AP 1010 and STA 1011. The r-TWT agreement may not include STA 1012. For example, STA 1012 may be a legacy STA or an EHT STA not scheduled by AP 1010 as part of the r-TWT agreement.

In an example, AP 1010 may transmit a beacon frame including a TWT element that indicates an r-TWT SP 1020 and TIDs allowed to be transmitted during the r-TWT SP 1020. The beacon frame may also include a quiet element indicating a quiet interval 1021.

Upon receiving the beacon frame, STA 1011 may enter a doze state and may remain in the doze state until the start of r-TWT SP 1020. STA 1012, which is not scheduled by AP 1010 for the r-TWT SP 1020, may transmit a data frame after receiving the beacon frame. However, STA 1012 must end its transmission before the start of r-TWT SP 1020.

During the r-TWT SP 1020, AP 1010 and STA 1011 may exchange an RTS frame and a CTS frame. Subsequently, AP 1010 may send a data frame to STA 1011. The data frame includes traffic having a TID from among the TIDs indicated as permitted to transmit during r-TWT SP 1020 (i.e., latency sensitive traffic) in the beacon frame. STA 1012 may not access the channel at least during quiet interval 1021 indicated in the beacon frame. When quiet interval 1021 or r-TWT SP 1020 ends, STA 1012 may resume its transmission. STA 1011 may enter doze state at the end of r-TWT SP 1020.

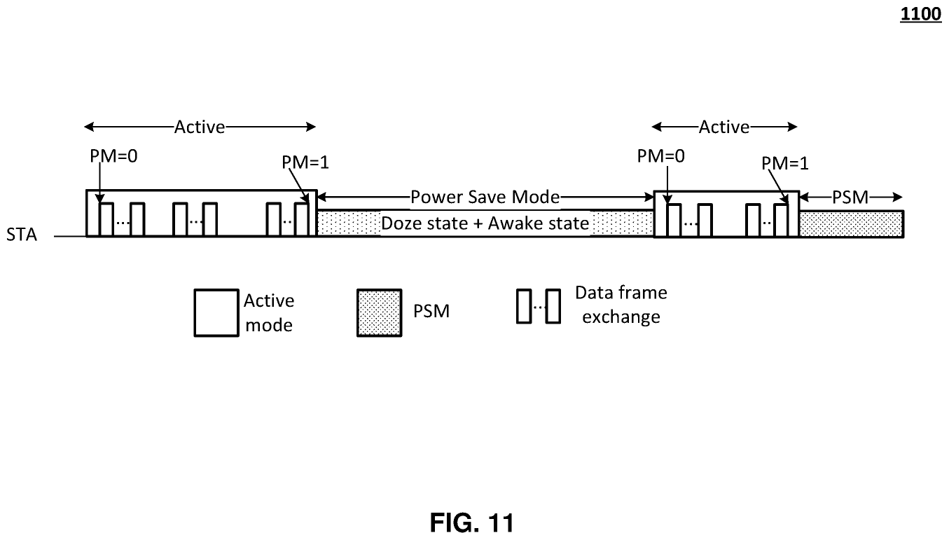

FIG. 11 illustrates an example 1100 of power save mode operation of a STA. The STA may be in one of two power states: an awake state and a doze state. In the awake state, the STA is fully powered. In the doze state, the STA consumes very low power and may not be able to transmit or receive frames. In addition, the STA may be in one of two power management modes: an active mode and a power save (PS) mode. In the active mode, the STA is continuously in the awake state and may receive and transmit frames at any time. In the PS mode, the STA may alternate between the awake state and the doze state. For example, the STA may enter the awake state to receive or transmit frames and then switch to the doze state to reduce power consumption. To change its power management mode, the STA may transmit a frame (e.g., a management frame, or a data frame) to an AP with which the STA is associated. The desired power management mode may be indicated in a power management (PM) subfield of a frame control field of the frame transmitted by the STA to the AP. Upon receiving an acknowledgement frame (e.g., an ack frame or a BlockAck frame) from the AP, the STA may switch to the indicated power management mode.

The AP may buffer individually addressed BUs addressed to STAs operating in a PS mode. The buffered BUs may be transmitted only at designated times.

In an example 1100, the STA may transmit to an AP a frame with a PM subfield set to 0 indicating its wish to operate in active mode. The AP may acknowledge the frame. The STA may then transmit and/or receive frames to/from the AP. At the end of the frame exchange, the STA may transmit to the AP a frame with a PM subfield set to 1 indicating its wish to switch to PS mode. Upon acknowledgment from the AP, the STA may change its power management mode from the active mode to the PS mode. While in the PS mode, the STA may enter the doze state and/or may switch to the awake state to check whether the AP has downlink buffered BUs addressed to the STA by receiving a traffic indication map (TIM) element in a beacon frame.

The STA may determine that a BU is buffered for the STA by receiving and interpreting the TIM element. The TIM element may include a traffic indication partial virtual bitmap maintained by the AP. The STA operating in PS mode may periodically listen for beacon frames, as determined by a listen interval parameter which may be indicated in association request and association response frames. On determining that a BU is currently buffered for it at the AP, the STA may transmit a power save poll (PS-Poll) frame to the AP. The AP may respond with the corresponding buffered BU immediately or may acknowledges the PS-Poll frame and respond with the corresponding BU at a later time.

The AP may maintain for an associated STA a power management status that indicates in which power management mode the STA is currently operating. The AP may, depending on the power management mode of the STA, temporarily buffer BUs destined to the STA. At a beacon interval, the AP may assemble the traffic indication partial virtual bitmap containing the buffer status per destination for STAs in PS mode and may transmit the traffic indication partial virtual bitmap in a TIM element of a beacon frame. When the AP receives a PS-Poll frame from a STA that is in PS mode, the AP may forward to the STA a buffered BU. The AP may respond after a SIFS either with a data or management frame, or with an ack frame, in which case the corresponding data or management frame is delayed. For a STA in PS mode, the AP may set a more data (MD) subfield of the response data or management frame to 1 or 0 to indicate the presence or the absence of further buffered BUs (not including the BU currently being transmitted) for the STA.

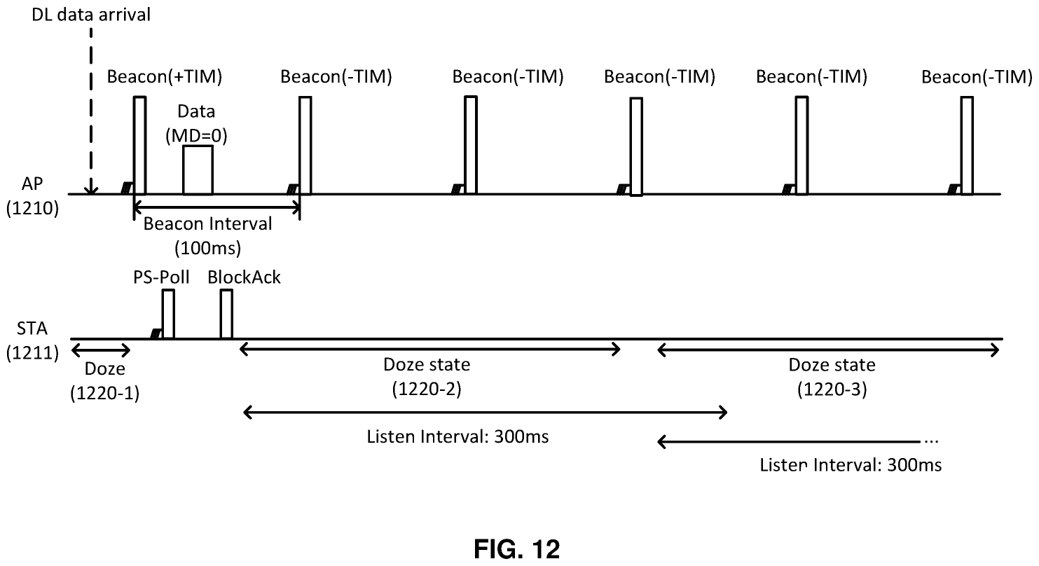

FIG. 12 illustrates an example 1200 of listening for beacon frames by a STA in power save mode. Example 1200 includes an AP 1210 and a STA 1211. AP 1210 may transmit a beacon frame including a TIM element periodically according to a beacon interval (e.g., 100 ms). Example 1100 begins with STA 1211 in a doze state 1220-1. At the end of doze state 1220-1, STA 1211 may wake up to receive a beacon frame from the AP 1210. In an example, STA 1211 receives a beacon frame including a TIM element with a TIM bit set to 1 for STA 1211. STA 1211 may transmit a power save poll (PS-Poll) frame to AP 1210 and may receive a frame including DL BU(s) from AP 1210. In example 1200, AP 1210 indicates to STA 1211 that a last buffered BU for STA 1211 is being transmitted in the frame by setting an MD subfield of a MAC header of the frame to zero. STA 1211 may enter a doze state 1220-2 after transmitting an acknowledgement frame (e.g., BlockAck) to the AP 1210. After entering doze state 1220-2, STA 1211 may wake up at least once within a listen interval of STA 1211 (e.g., 300 ms) to receive a beacon frame including a TIM element. On receiving a beacon frame including a TIM bit set to 0 for STA1211, STA 1211 may return to a doze state 1220-3 until it wakes up to receive another beacon frame based on the listen interval of STA 1211.

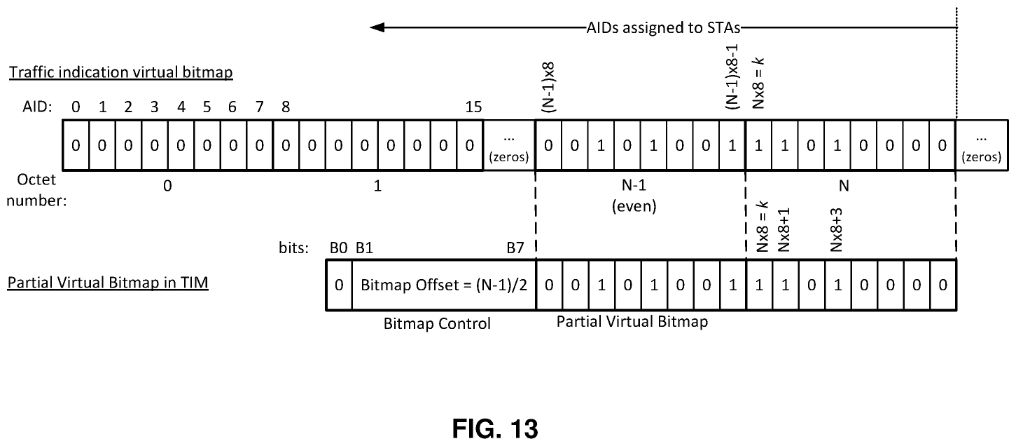

FIG. 13 illustrates an example 1300 of traffic indication map (TIM) element construction by an AP. As mentioned above, an AP may use a TIM element to identify the STAs for which traffic is pending and buffered at the AP. As shown in FIG. 13, a TIM element may include bitmap control field(s) and partial virtual bitmap field(s).

B1 to B7 of the bitmap control field(s) provide a bitmap offset indicating which AlDs are included in a partial virtual bitmap field. The TIM information is coded in the partial virtual bitmap field(s). The AP may identify STAs for which the AP is prepared to deliver buffered BUs by setting bits in the partial virtual bitmap that correspond to the respective AlDs of the STAs. AID 0 (zero) is reserved to indicate the presence of buffered group addressed BUs. In an implementation, the traffic indication partial virtual bitmap includes 2008 bits and is organized into 251 octets such that bit number N (0␣N␣2007) in the bitmap corresponds to bit number (N mod 8) in octet number ␣N/8␣ where the low order bit of each octet is bit number 0, and the high order bit is bit number 7.

For example, a bitmap offset field set to 1 indicates third and fourth AID octets (AID 16 to AID 31) included as part of the partial virtual bitmap as bitmap offset calculation (N−1)/2. A bitmap offset field set to 1 and a partial virtual bitmap field (e.g., 2 octets) set to 00101001 11010000 as an ascending order may indicate that the AP has DL BUs addressed to STAs with AlDs equal to 18, 20, 23, 24, 25, and 27.

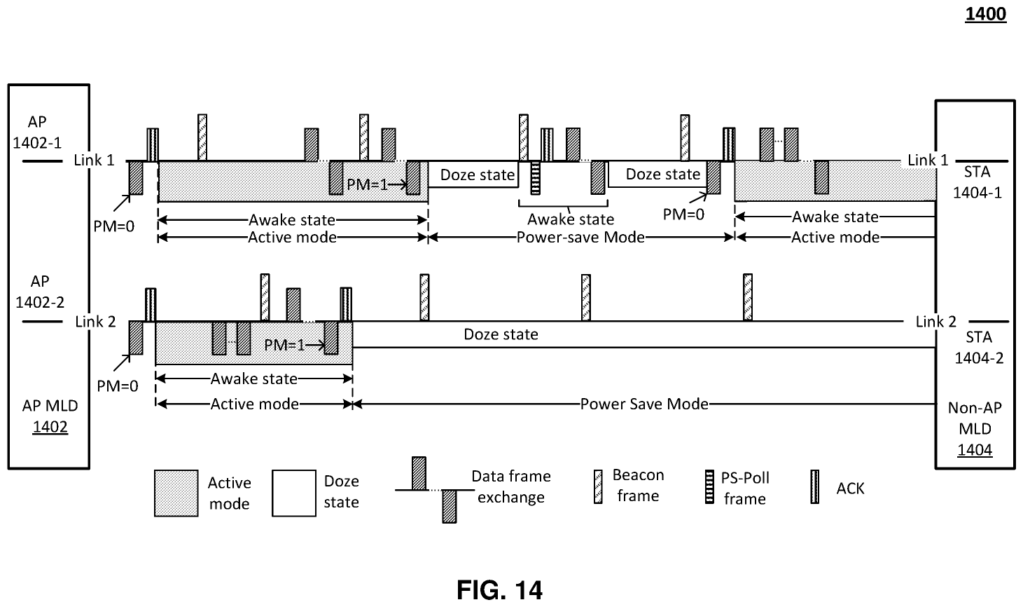

During multi-link operation, a STA affiliated with a non-AP MLD and operating on an enabled link (a link having at least of TID mapped to it) may maintain its own power management mode and power states. Frame exchanges on the enabled link are possible when the STA is in the awake state. FIG. 14 is an example 1400 that illustrates the power save operation of a STA affiliated with a non-AP MLD during multi-link operation. As shown in FIG. 14, example 1400 includes an AP MLD 1402 and a non-AP MLD 1404 communicatively coupled by a first link (link 1) and a second link (link 2). AP MLD 1402 has two APs 1402-1 and 1402-2 affiliated with it, while STA MLD 1404 has two STAs 1404-1 and 1404-2 affiliated with it.

As shown, initially, both STAs 1404-1 and 1404-2 are in active mode and are involved in frame exchanges with APs 1402-1 and 1402-2 respectively. STAs 1404-1 and 1404-2 may indicate being in active mode by setting to 0 a Power Management (PM) subfield of a Frame Control field of a transmitted frame. At a first time, STA 1404-2 indicates to AP 1402-2 that it is entering a power save mode (e.g., sets PM bit to 1 in a transmitted frame) and transitions to a doze state. STA 1404-2 remains in the doze state for the remaining time of example 1400. At a second time, STA 1404-2 enters a power save mode (e.g., sets PM bit to 1 in a transmitted frame). While operating in the power save mode, STA 1404-1 wakes up to receive a beacon frame transmitted by AP 1402-2 and determines that AP MLD 1402 has BUs for non-AP MLD 1404 that belong to TID(s) mapped to Link 1. Based on this determination, STA 1404-1 indicates to AP 1402-1 that it has transitioned to awake state by transmitting a PS-Poll frame or a U-APSD trigger frame on link 1. STA 1404-1 may then participate in a frame exchange with AP 1402-1 while in the awake state. STA 1404-1 may return to the doze after the frame exchange.

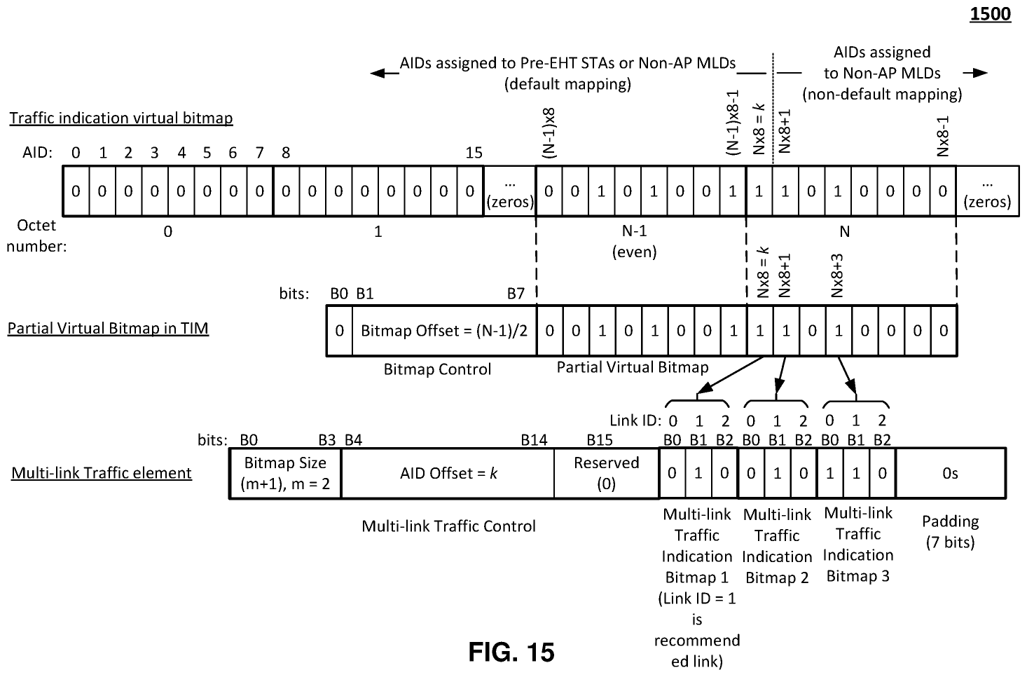

FIG. 15 illustrates an example 1500 of multi-link traffic element construction by an AP. In an example embodiment, an AP MLD may assign a single AID to a non-AP MLD upon successful multi-link setup. All STAs affiliated with the non-AP MLD may have the same AID as the one assigned to the non-AP MLD during multi-link setup. An AP MLD may indicate pending buffered traffic for non-AP MLDs using a partial virtual bitmap of a TIM element in a beacon frame. An AP MLD may recommend to a non-AP MLD to use one or more enabled links to retrieve individually addressed buffered BU(s). An AP MLD may buffer a BU at the AP MLD if the TID of the BU is not mapped to any link on which a corresponding STA of the non-AP MLD is in active mode, and the AP MLD may set a bit in the partial virtual bitmap of the TIM element that corresponds to the AID of the non-AP MLD to 1.

An AP affiliated with an AP MLD may include the multi-link traffic element in a beacon frame it transmits if at least one of the associated non-AP MLD has successfully negotiated a TID-to-link mapping with the AP MLD and the AP MLD has buffered BU(s) for the non-AP MLD. The multi-link traffic element may include per-link traffic indication bitmap subfield(s) that corresponds to the AID(s) of the non-AP MLD(s), starting from the bit number k of the traffic indication virtual bitmap, in the per-link traffic indication bitmap list field. The AID Offset subfield of the multi-link traffic control field of the multi-link traffic element contains the value k. The order of the per-link traffic indication bitmap subfield(s) follows the order of the bits that are set to 1 in the partial virtual bitmap subfield of the TIM element that corresponds to the AID(s) of the non-AP MLD(s). If a non-AP MLD has successfully negotiated a TID-to-link mapping with an AP MLD with a non-default mapping, the bit position i of the per-link traffic indication bitmap subfield that corresponds to the link with the link ID equals to i on which a STA of the non-AP MLD is operating shall be set to 1 if the AP MLD has buffered BU(s) with TID(s) that are mapped to that link or management MAC protocol units (MMPDUs) for that non-AP MLD, otherwise the bit is set to 0. If a non-AP MLD is in a default mapping mode, the bit position i of the per-link traffic indication bitmap subfield that corresponds to the link with the link ID equal to i on which a STA affiliated with the non-AP MLD is operating may be set to 1 to indicate to the non-AP MLD a link on which buffered BU(s) should be retrieved.

When a non-AP MLD that is in the default mapping mode detects that the bit corresponding to its AID is 1 in the TIM element, any STA affiliated with the non-AP MLD may issue a PS-Poll frame to retrieve buffered BU(s) in the AP MLD. When a non-AP MLD that is in the default mapping mode detects that the bit corresponding to its AID is 1 in the TIM element and the multi-link traffic element is present in a beacon frame, any STA affiliated with the non-AP MLD that operates on the link(s) indicated in the multi-link traffic element may issue a PS-Poll frame to retrieve buffered BU(s) in the AP MLD.

When a non-AP MLD that has successfully negotiated a TID-to-link mapping detects that the bit corresponding to its AID is equal to 1 in the TIM element and any bit of the per-link traffic indication bitmap subfield that corresponds to a link on which a STA affiliated with the non-AP MLD is operating is equal to 1 in the multi-link traffic element, the STA affiliated with the non-AP MLD that operates on that link may issue a PS-Poll frame to retrieve buffered BU(s) from the AP MLD. When an AP affiliated with an AP MLD receives a PS-Poll frame from a STA affiliated with an associated non-AP MLD that is in power save mode, it may transmit buffered BU(s) to the STA, if one is available and not discarded for implementation dependent reasons, otherwise it may transmit a QoS null frame. If a buffered BU is an MMPDU that is intended for a STA affiliated with a non-AP MLD and that is not a measurement MMPDU, and if it is transmitted on a link on which another STA affiliated with the same non-AP MLD is operating, following the procedure above, the frame may carry information to determine the intended destination STA affiliated with the non-AP MLD.

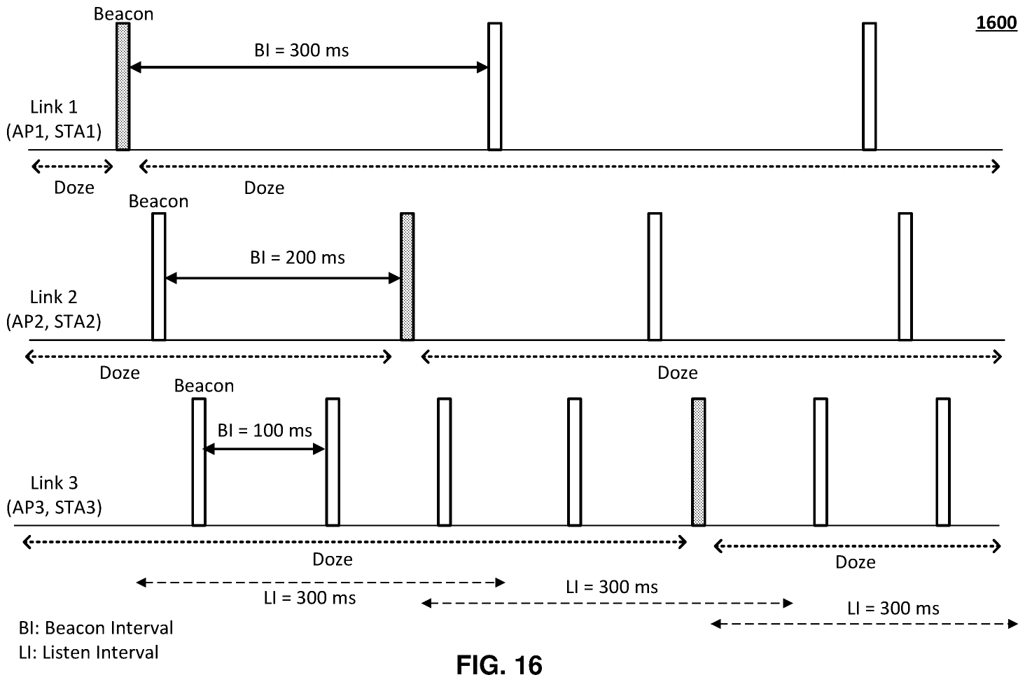

FIG. 16 illustrates an example 1600 of listening for beacon frames over multi-link by a non-AP MLD in power save mode. As shown in FIG. 16, the non-AP MLD may have three affiliated STAs (STA1, STA2, and STA3). The non-AP MLD may be associated with an AP MLD having three affiliated APs (AP1, AP2, and AP3). The non-AP MLD and the AP MLD may be communicatively coupled over three links (link 1, link 2, and link 3).

During multi-link (re) setup, the value carried in a listen interval field in an (re)-association request frame sent by a STA affiliated with a non-AP MLD to an AP affiliated with an AP MLD is requested at the MLD level. The value of the listen interval field shall be in units of the maximum value of beacon intervals corresponding to the links that the non-AP MLD intends to setup in the (re-) association request frame. The AP affiliated with the AP MLD may reject the multi-link (re) setup because the listen interval requested by the non-AP MLD is too large. After successful multi-link (re) setup, the AP MLD shall use the listen interval in determining the lifetime of frames that it buffers for the non-AP MLD. The AP MLD may delete buffered BUs for implementation dependent reasons, including the use of an aging function and availability of buffers where the aging function is based on the listen interval indicated by the non-AP MLD in its (re-) association request frame.

If all STAs affiliated with the non-AP MLD and operating on enabled links are in power save mode, at least one of these STAs may wake up to receive at least one beacon frame scheduled for transmission within the interval of duration equal to the listen interval indicated by the non-AP MLD in its (re-) association request frame, starting from the last target beacon transmission time (TBTT) for which another STA or the same STA affiliated with the non-AP MLD was awake.

In example 1600, the AP MLD has three affiliated APs: AP1 operates on link 1, AP2 operates on link 2, and AP3 operates on link 3. The beacon intervals of link 1, link 2, and link 3 are 300 ms, 200 ms, and 100 ms, respectively. STA1 sends an association request frame to AP1 affiliated with the AP MLD. STA1 requests three links to be setup (link 1 between AP1 and STA1, link 2 between AP2 and STA2, and link 3 between AP3 and STA3) and sets the value of a listen interval field carried in the association request frame to 1 and the value of a listen interval field in units of 300 ms. Therefore, the listen interval requested by the non-AP MLD is 300 ms. AP1 accepts the three links for this multi-link setup (link 1 between AP1 and STA1, link 2 between AP2 and STA2, and link 3 between AP3 and STA3) by sending an association response frame to STA1.

After the successful multi-link setup, STA2 and STA3 enter a power save mode. In an example, STA1 may enter the power save mode (e.g., signals PM=1) after STA2 and STA3 entered the power save mode. In this case, the AP MLD may buffer DL BUs to the non-AP MLD at least for 300 ms. As shown in FIG. 16, STA 1 receives the first beacon frame on link 1. Subsequently, a STA affiliated with the non-AP MLD is required to wake up to receive at least one beacon frame within the first listen interval, for example, STA1 may receive the second beacon frame on link 1, STA2 may receive the second beacon frame on link 2, or STA 3 may receive the third beacon frame on link 3. In example 1600, STA2 receives the second beacon frame on link2 within the first listen interval, and STA 3 receives the fifth beacon frame on link 3 within the second listen interval.

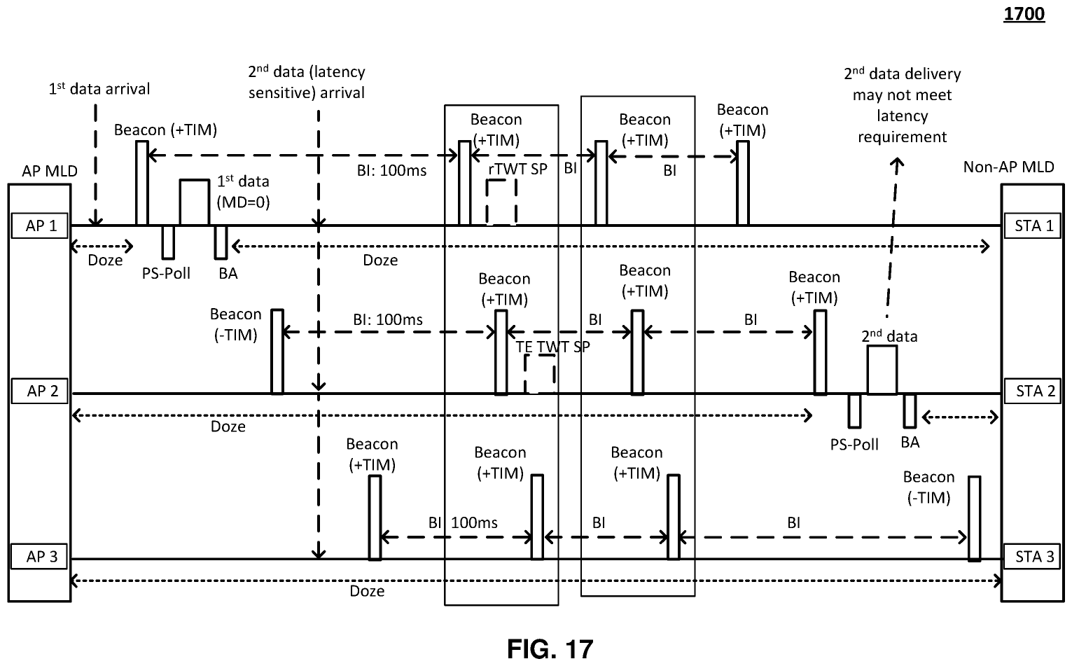

FIG. 17 is an example 1700 that illustrates a problem that may arise using an existing method for listening for beacon frames during a multi-link power save mode. As shown in FIG. 17, example 1700 includes an AP MLD and a non-AP MLD. The AP MLD may include a plurality of affiliated APs, AP1, AP2, and AP3. The non-AP MLD may include a plurality of affiliated STAs, STA1, STA2, and STA3. The non-AP MLD may operate in a power save mode.

In example 1700, STA1, STA2, and STA3 affiliated with the non-AP MLD may initially be in a doze state. The AP MLD may transmit a beacon frame including a traffic indication map (TIM) element and/or a multi-link traffic element periodically based on a beacon interval (BI) (e.g., 100 ms) over each link (link 1, link 2, link 3) between the non-AP MLD and the AP MLD. STA1 may wake up to receive a beacon frame including the traffic indication map (TIM) element and/or the multi-link traffic element to determine whether the AP MLD has downlink BUs addressed to the non-AP MLD. In example 1700, AP1 having downlink BU(s) addressed to the non-AP MLD may transmit a beacon frame indicating the downlink BU(s) for the non-AP MLD (e.g., via a TIM bit associated with the non-AP MLD set to 1). STA1 receiving the beacon frame may transmit a power save poll (PS-Poll) frame to AP1 and may receive the downlink BU(s) from the AP1. On receiving a frame indicating a last buffered frame with a more data (MD) subfield in a MAC header set to 0, STA1 may enter the doze state after transmitting an acknowledgement frame to the AP MLD. STA2 and STA3 may maintain the doze state during the time in which STA1 receives the beacon frame and the downlink BU(s) from AP1 of the AP MLD.

In an example, a data frame with latency sensitive traffic to be sent to the non-AP MLD may arrive at the AP MLD after STA1 enters the doze state. The AP MLD may transmit a beacon frame indicating the downlink BU(s) for the non-AP MLD (e.g., via a TIM bit associated with the non-AP MLD set to 1). STA1, STA2 and STA3 may all remain in the doze state not receiving one or more successive beacon frames indicating the downlink BU(s) for the non-AP MLD. In an example, STA2 may wake up to receive a beacon frame indicating the downlink BU(s) for the non-AP MLD once within a listen interval of the non-AP MLD (e.g., 400 ms). However, the resulting data delivery may not meet the latency requirements.

As a result, STA1, STA2, and STA3 may not transmit a PS-Poll frame to retrieve the downlink BU (a) with latency sensitive traffic for a couple of beacon intervals. The downlink BU(s) with latency sensitive traffic may not be delivered to the non-AP MLD in a timely manner to meet a latency requirement of a service. Further, the AP MLD may allocate one or more r-TWT SPs and/or one or more TE TWT SPs for STA1 and STA2 using beacon frames to provide a prioritized access for STA1 and STA2 to transmit a PS-Poll frame. However, with STA1 and STA2 in the doze state and not receiving the beacon frames, the allocated TWT SPs to access the channel may remain unused and the allocated resources may be lost.

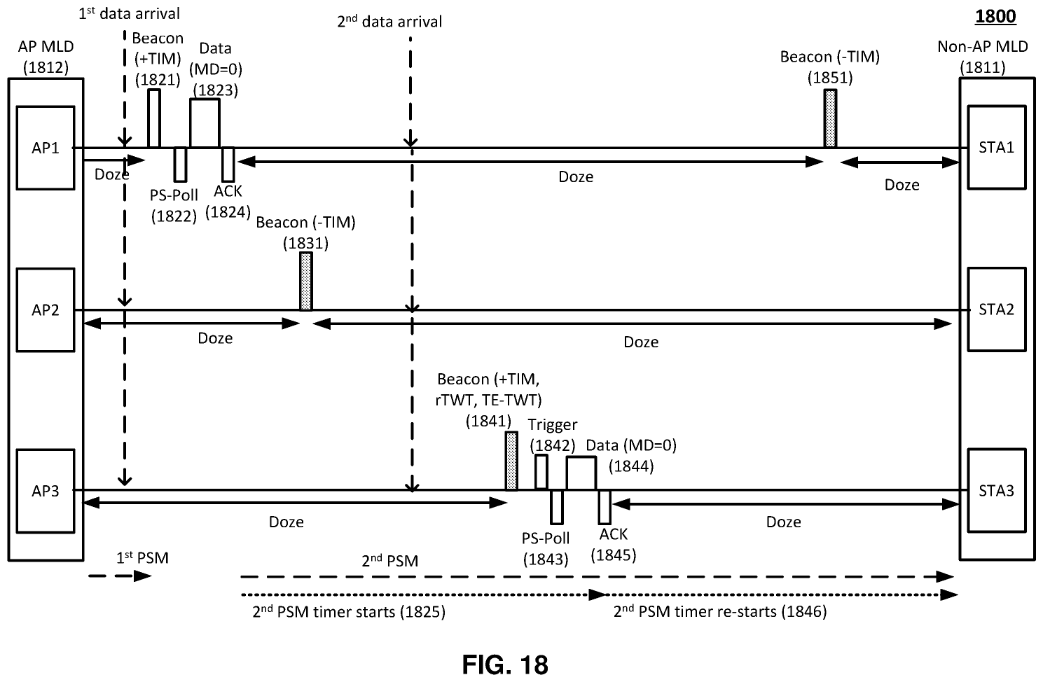

FIGS. 18 to 24 illustrate examples of a multi-link enhanced power save mode comprising a first power save mode and a second power save mode in accordance with embodiments of the present disclosure. As further described below, the proposed power save mode addresses the above-described deficiencies of existing technologies.

In example embodiments, STAs on enabled links and affiliated with a non-AP multi-link device (MLD) may change a power management mode from an active mode to a first power save mode. During the first power save mode, at least one of the STAs of the non-AP MLD wakes to listen for at least one beacon frame on one of the enabled links within a listen interval of the non-AP MLD. The STA of the non-AP MLD may receive from an AP affiliated with an AP MLD while in the first power save mode, a beacon frame comprising a traffic indication map (TIM) element and/or a multi-link traffic element indicating downlink (DL) buffered units (BUs) for the non-AP MLD. The STA of the non-AP MLD may transmit a frame to retrieve the DL BUs. The frame to retrieve the DL BUs may be a power save poll (PS-Poll) frame or a trigger frame. The STA of the non-AP MLD that sent the PS-Poll frame or the trigger frame may receive DL BUs from the AP MLD. In response to or after receiving of the DL BUs for the non-AP MLD, the non-AP MLD may change the power management mode from the first power save mode to a second power save mode. During the second power save mode, STAs of the non-AP MLD may wake to listen for beacon frames on the enabled links based on a timer. For example, during the second power save mode, the STAs of the non-AP MLD may wake to listen for a beacon frame at each target beacon transmission time on the enabled links until the timer expires. In another example, during the second power save mode, the STAs of the non-AP MLD may wake to listen for a beacon frame more frequently than while in the first power same mode.

In an example embodiment, changing the power management mode from the first power save mode to the second power save mode may be in response to receiving the downlink BUs comprising at least one latency sensitive BU at the non-AP MLD. The latency sensitive BU may be indicated as a specific TID by the AP MLD or identified as one or more specific access categories.

In an example embodiment, the timer value may be determined based on the largest beacon interval among beacon intervals of the enabled links, a listen interval of the non-AP MLD, or a value pre-configured at the non-AP MLD and the AP MLD. For example, the timer value may be equal to the largest beacon interval among beacon intervals of the enabled links, a listen interval of the non-AP MLD, or a value pre-configured at the non-AP MLD and the AP MLD. The timer may run for a period of time determined based on the timer value. For example, the timer may run for a period of time equal to the timer value.

In an example embodiment, the non-AP MLD may maintain the second power save mode when the timer is running.

In an example embodiment, the timer may start or restart in response to receiving both a traffic indication map (TIM) element indicating downlink BU(s) for the non-AP MLD and at least one downlink BU addressed to the non-AP MLD.

In an example embodiment, the non-AP MLD may change the power management mode from the second power save mode to the first power save mode in response to the timer expiring or expiration of the timer.

In an example embodiment, the timer value may be indicated in an association response frame, a beacon frame, and/or a probe response frame.

In an example embodiment, the non-AP MLD may indicate to the AP MLD changing the power management mode from the active mode to the first power save mode by sending a frame with a power management (PM) subfield of a frame control field set to 1.

In an example embodiment, the non-AP MLD, during the second power save mode, may receive a beacon frame comprising a traffic indication map (TIM) element and/or a multi-link traffic element indicating downlink BUs for the non-AP MLD and a broadcast target wake time (TWT) element indicating a restricted TWT service period (SP) and/or a TE TWT SP.

In example embodiments, an AP MLD may determine that a non-AP MLD is in a second power save mode based on a timer and presence of DL BUs for the non-AP MLD. The AP MLD may transmit a beacon frame comprising a traffic indication map (TIM) element and/or a multi-link traffic element indicating DL BUs for the non-AP MLD and a broadcast target wake time (TWT) element indicating one or more r-TWT SPs and/or TE TWT SPs for the non-AP MLD in the second power save mode. The AP MLD may receive a power save poll (PS-Poll) frame or a trigger frame and may transmit DL BUs to the non-AP MLD.

In an example embodiment, the AP MLD may indicate the timer value in an association response frame, in a beacon frame, and/or in a probe response frame.

FIG. 18 is an example 1800 that illustrates an example operation of a multi-link power save mode according to an embodiment. As shown in FIG. 18, example 1800 includes an AP MLD 1812 and a non-AP MLD 1811. AP MLD 1812 includes a plurality of affiliated APs, AP1, AP2, and AP3. Non-AP MLD 1811 includes a plurality of affiliated STAs, STA1, STA2, and STA3. AP MLD 1812 and non-AP MLD 1811 may be communicatively coupled by a plurality of links. TIDs may be mapped to each of the plurality of links rendering them enabled links.

In example 1800, STA1, STA2, and STA3 may change a power management mode from an active mode to a first power save mode. During the first power save mode, at least one of STA1, STA2, and STA3 wakes to listen for at least one beacon frame on one of the enabled links within a listen interval of non-AP MLD 1811. STA1, STA2, and STA3 may then each enter a doze state.

AP MLD 1812 may be configured transmit a beacon frame including a traffic indication map (TIM) element and/or a multi-link traffic element periodically based on a beacon interval over each link. In example 1800, AP1 of AP MLD 1812 may transmit a beacon frame 1821 indicating a TIM bit associated with non-AP MLD 1811 set to 1 to indicate presence of DL buffered BUs for non-AP MLD 1811. STA1 may wake up to receive beacon frame 1821. On receiving beacon frame 1821 with the TIM bit set to 1, STA1 may transmit a power save poll (PS-Poll) frame 1822 to AP1 to retrieve the DL buffered BUs and may receive DL BU(s) from AP1. AP1 may set a more data (MD) subfield in a header of an MPDU of a last buffered frame 1823 to 0 to indicate that frame 1823 is the last buffered frame for non-AP MLD 1811. On receiving frame 1823, STA1 transmits an acknowledgment frame 1824 and may return to the doze state. STA2 and STA3 may maintain the doze state during the time that STA1 receives beacon frame 1821 and the DL BUs from the AP1 of AP MLD 1812.

On receiving the TIM element in beacon frame 1821 indicating DL BUs for non-AP MLD 1811 and the DL BU(s) from AP MLD 1812, non-AP MLD 1811 may change the power management mode from the first power save mode to a second power save mode. Further, non-AP MLD 1811 may start a timer 1825 (e.g., a second power save mode (PSM) timer) which value may be equal to one beacon interval. While in the second power save mode, STA1, STA2, and STA3 may wake from the doze state to listen for beacon frames on the enabled links at each target beacon transmission time (TBTT) on the enabled links while timer 1825 runs. In example 1800, STA2 may wake to listen for a beacon frame at a TBTT and may receive a beacon frame 1831 from AP2 of AP MLD 1812 comprising a TIM element indicating no DL BU(s) for non-AP MLD 1811.

Subsequently, AP3 of AP MLD 1812 having downlink buffered BU(s) may transmit a beacon frame 1841 comprising a TIM element indicating DL BU(s) for non-AP MLD 1811. Beacon frame 1841 may further comprise one or more broadcast target wake time (TWT) element indicating a restricted TWT service period (SP) and/or a TE TWT SP. STA3 operating in the second power save mode may wake at the TBTT and may receive beacon frame 1841. In example 1800, beacon frame 1841 indicates a TE TWT SP, and AP3 may transmit a trigger frame 1842 to trigger transmission of a PS-Poll frame 1843 from STA3 during the TE TWT SP indicated in the beacon frame 1841. STA3 responds to trigger frame 1842 with PS-Poll frame 1843 to AP MLD 1812 and receives DL BU(s) from AP3. AP3 may set a more data (MD) subfield in a header of an MPDU of a last buffered frame 1844 to 0 to indicate that frame 1844 is the last buffered frame for non-AP MLD 1811. On receiving frame 1824, STA3 transmits an acknowledgment frame 1845 and may return to the doze state. STA1 and STA2 may maintain the doze state during the time that STA3 receives beacon frame 1841 and the DL BUs from the AP3 of AP MLD 1812.

In an example, on receiving both the TIM element in beacon frame 1841 indicating DL BUs for non-AP MLD 1811 and the DL BU(s) from AP MLD 1812, non-AP MLD 1811 may maintain the second power save mode and may re-start a timer 1846 (e.g., the second power save mode timer) with a value equal to one beacon interval. Subsequently, with STA1, STA2, and STA3 in the doze state, STA1 may wake at a TBTT to listen for a beacon frame 1851 transmitted by AP1 of AP MLD 1812.

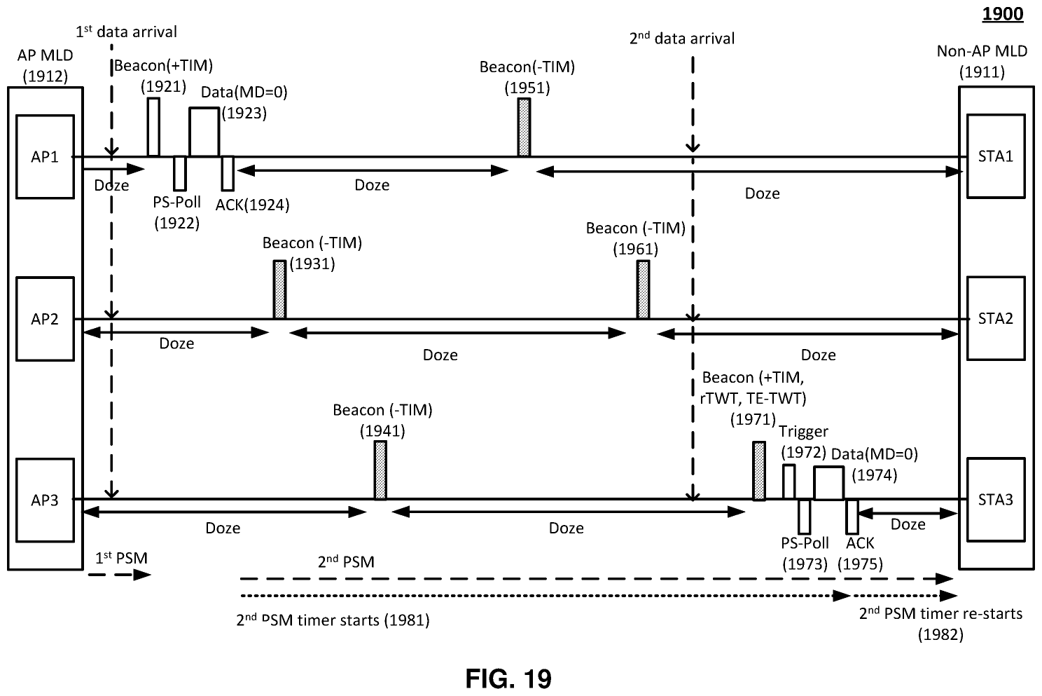

FIG. 19 is an example 1900 that illustrates an example operation of a multi-link power save mode according to an embodiment. As shown in FIG. 19, example 1900 includes an AP MLD 1912 and a non-AP MLD 1911. AP MLD 1912 includes a plurality of affiliated APs, AP1, AP2, and AP3. Non-AP MLD 1911 includes a plurality of affiliated STAs, STA1, STA2, and STA3. AP MLD 1912 and non-AP MLD 1911 may be communicatively coupled by a plurality of links. TIDs may be mapped to each of the plurality of links rendering them enabled links.

In example 1900, STA1, STA2, and STA3 may change a power management mode from an active mode to a first power save mode. During the first power save mode, at least one of STA1, STA2, and STA3 wakes to listen for at least one beacon frame on one of the enabled links within a listen interval of non-AP MLD 1911. STA1, STA2, and STA3 may then each enter a doze state.

AP MLD 1912 may be configured transmit a beacon frame including a traffic indication map (TIM) element and/or a multi-link traffic element periodically based on a beacon interval over each link. In example 1900, AP1 of AP MLD 1912 may transmit a beacon frame 1921 indicating a TIM bit associated with non-AP MLD 1911 set to 1 to indicate presence of DL buffered BUs for non-AP MLD 1911. STA1 may wake up to receive beacon frame 1921. On receiving beacon frame 1921 with the TIM bit set to 1, STA1 may transmit a power save poll (PS-Poll) frame 1922 to AP1 to retrieve the DL buffered BUs and may receive DL BU(s) from AP1. AP1 may set a more data (MD) subfield in a header of an MPDU of a last buffered frame 1923 to 0 to indicate that frame 1923 is the last buffered frame for non-AP MLD 1911. On receiving frame 1923, STA1 transmits an acknowledgment frame 1924 and may return to the doze state. STA2 and STA3 may maintain the doze state during the time that STA1 receives beacon frame 1921 and the DL BUs from the AP1 of AP MLD 1912.

On receiving the TIM element in beacon frame 1921 indicating DL BUs for non-AP MLD 1911 and the DL BU(s) from AP MLD 1912, non-AP MLD 1911 may change the power management mode from the first power save mode to a second power save mode. Further, non-AP MLD 1911 may start a timer 1981 (e.g., a second power save mode (PSM) timer) which value may be equal to two beacon intervals. While in the second power save mode, STA1, STA2, and STA3 may wake from the doze state to listen for beacon frames on the enabled links at each target beacon transmission time (TBTT) on the enabled links while timer 1981 runs. In example 1900, STA1 may wake to receive a beacon frame 1951 from AP1; STA2 may wake to receive beacon frames 1931 and 1961 from AP2; and STA3 may wake to receive a beacon frame 1941 from AP 3. In example 1900, beacon frames 1931, 1941, 1951, and 1961 may each comprise a TIM element indicating no DL BU(s) for non-AP MLD 1911.

Subsequently, AP3 of AP MLD 1912 having downlink buffered BU(s) may transmit a beacon frame 1971 comprising a TIM element indicating DL BU(s) for non-AP MLD 1911. Beacon frame 1971 may further comprise one or more broadcast target wake time (TWT) element indicating a restricted TWT service period (SP) and/or a TE TWT SP. STA3 operating in the second power save mode may wake at the TBTT and may receive beacon frame 1971. In example 1900, beacon frame 1971 indicates a TE TWT SP, and AP3 may transmit a trigger frame 1971 to trigger transmission of a PS-Poll frame 1973 from STA3 during the TE TWT SP indicated in the beacon frame 1971. STA3 responds to trigger frame 1971 with PS-Poll frame 1973 to AP MLD 1912 and receives DL BU(s) from AP3. AP3 may set a more data (MD) subfield in a header of an MPDU of a last buffered frame 1974 to 0 to indicate that frame 1974 is the last buffered frame for non-AP MLD 1911. On receiving frame 1974, STA3 transmits an acknowledgment frame 1975 and may return to the doze state. STA1 and STA2 may maintain the doze state during the time that STA3 receives beacon frame 1971 and the DL BUs from the AP3 of AP MLD 1912.

In an example, on receiving both the TIM element in beacon frame 1971 indicating DL BUs for non-AP MLD 1911 and the DL BU(s) from AP MLD 1912, non-AP MLD 1911 may maintain the second power save mode and may re-start a timer 1982 (e.g., the second power save mode timer) with a value equal to two beacon intervals. While in the second power save mode, STA1, STA2, and STA3 may wake from the doze state to listen for beacon frames on the enabled links at each TBTT on the enabled links while timer 1982 runs.

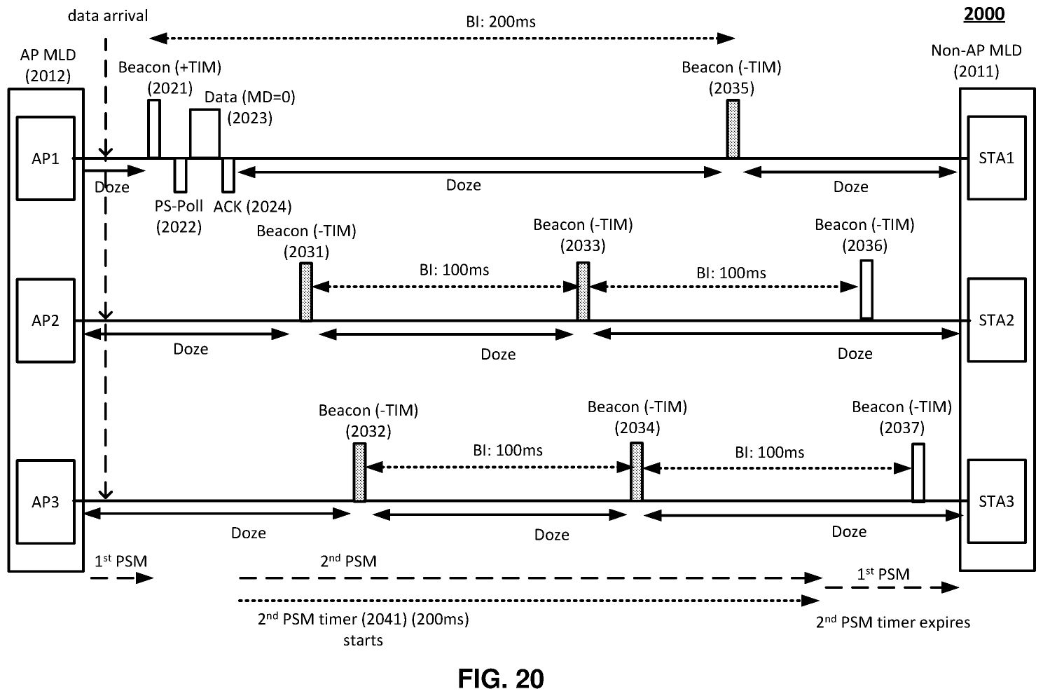

FIG. 20 is an example 2000 that illustrates an example operation of a multi-link power save mode according to an embodiment. As shown in FIG. 20, example 2000 includes an AP MLD 2012 and a non-AP MLD 2011. AP MLD 2012 includes a plurality of affiliated APs, AP1, AP2, and AP3. Non-AP MLD 2011 includes a plurality of affiliated STAs, STA1, STA2, and STA3. AP MLD 2012 and non-AP MLD 2011 may be communicatively coupled by a plurality of links. TIDs may be mapped to each of the plurality of links rendering them enabled links.

In example 2000, STA1, STA2, and STA3 may change a power management mode from an active mode to a first power save mode. During the first power save mode, at least one of STA1, STA2, and STA3 wakes to listen for at least one beacon frame on one of the enabled links within a listen interval of non-AP MLD 2011. STA1, STA2, and STA3 may then each enter a doze state.

AP MLD 2012 may be configured transmit a beacon frame including a traffic indication map (TIM) element and/or a multi-link traffic element periodically based on a beacon interval over each link. In example 2000, AP1 of AP MLD 2012 may transmit a beacon frame 2021 indicating a TIM bit associated with non-AP MLD 2011 set to 1 to indicate presence of DL buffered BUs for non-AP MLD 2011. STA1 may wake up to receive beacon frame 2021. On receiving beacon frame 2021 with the TIM bit set to 1, STA1 may transmit a power save poll (PS-Poll) frame 2022 to AP1 to retrieve the DL buffered BUs and may receive DL BU(s) from AP1. AP1 may set a more data (MD) subfield in a header of an MPDU of a last buffered frame 2023 to 0 to indicate that frame 2023 is the last buffered frame for non-AP MLD 2011. On receiving frame 2023, STA1 transmits an acknowledgment frame 2024 and may return to the doze state. STA2 and STA3 may maintain the doze state during the time that STA1 receives beacon frame 2021 and the DL BUs from the AP1 of AP MLD 2012.

On receiving the TIM element in beacon frame 2021 indicating DL BUs for non-AP MLD 2011 and the DL BU(s) from AP MLD 2012, non-AP MLD 2011 may change the power management mode from the first power save mode to a second power save mode. Further, non-AP MLD 2011 may start a timer 2041 (e.g., a second power save mode (PSM) timer) with a value equal the largest beacon interval among the beacon intervals of the enabled link. In example 2000, a first link between AP1 and STA1 may have a BI of 200 ms, while a second link between AP2 and STA2 and a third link between AP3 and STA3 may have Bis of 100 ms. As such, the value of timer 2041 may be set to 200 ms. During the second power save mode, STA1, STA2, and STA3 may wake to listen for beacon frames on the enabled links at each target beacon transmission time (TBTT) on the enabled links while timer 2041 runs. In example 2000, STA2 may wake at each TBTT and receive beacon frames 2031 and 2033; STA3 may wake at each TBTT and receive beacon frames 2032 and 2034; and STA may wake at each TBTT and receive beacon frame 2035. Beacon frames 2031, 2032, 2034, and 2035 may each comprise a TIM element indicating no DL BU(s) for non-AP MLD 2011.

When timer 2041 expires, non-AP MLD 2011 may change the power management mode from the second power save mode to the first power save mode. While in the first power save mode, at least one of STA1, STA2, and STA3 of non-AP MLD 2011 may wake to listen for at least one beacon frame on one of the enabled links within a listen interval of non-AP MLD 2011. In example 2000, after switching to the first power save, STA2 and STA3 may stay in the doze state and may not wake to listen for upcoming beacon frames 2036 and 2037 transmitted by AP2 and AP3 respectively.

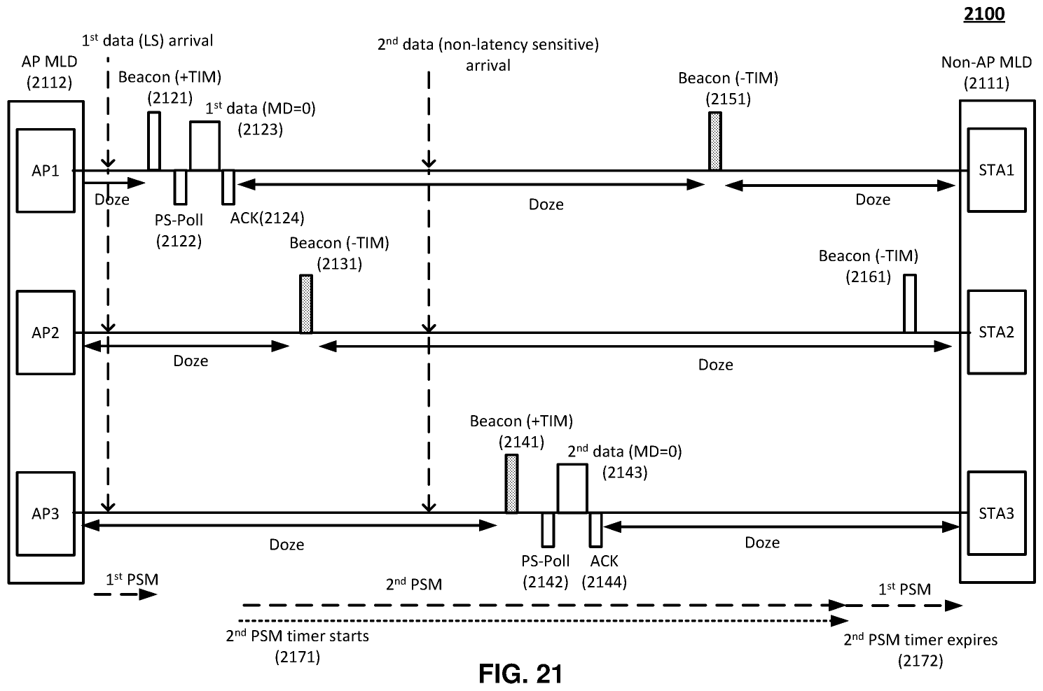

FIG. 21 is an example 2100 that illustrates an example operation of a multi-link power save mode according to an embodiment. As shown in FIG. 21, example 2100 includes an AP MLD 2112 and a non-AP MLD 2111. AP MLD 2112 includes a plurality of affiliated APs, AP1, AP2, and AP3. Non-AP MLD 2111 includes a plurality of affiliated STAs, STA1, STA2, and STA3. AP MLD 2112 and non-AP MLD 2111 may be communicatively coupled by a plurality of links. TIDs may be mapped to each of the plurality of links rendering them enabled links.

In example 2100, STA1, STA2, and STA3 may change a power management mode from an active mode to a first power save mode. During the first power save mode, at least one of STA1, STA2, and STA3 wakes to listen for at least one beacon frame on one of the enabled links within a listen interval of non-AP MLD 2111. STA1, STA2, and STA3 may then each enter a doze state.

AP MLD 2112 may be configured transmit a beacon frame including a traffic indication map (TIM) element and/or a multi-link traffic element periodically based on a beacon interval over each link. In example 2100, AP1 of AP MLD 1812 may transmit a beacon frame 2121 indicating a TIM bit associated with non-AP MLD 2111 set to 1 to indicate presence of DL buffered BUs for non-AP MLD 2111. STA1 may wake up to receive beacon frame 2121. On receiving beacon frame 2121 with the TIM bit set to 1, STA1 may transmit a power save poll (PS-Poll) frame 2122 to AP1 to retrieve the DL buffered BUs and may receive DL BU(s) from AP1. AP1 may set a more data (MD) subfield in a header of an MPDU of a last buffered frame 2123 to 0 to indicate that frame 2123 is the last buffered frame for non-AP MLD 2111. On receiving frame 2123, STA1 transmits an acknowledgment frame 2124 and may return to the doze state. STA2 and STA3 may maintain the doze state during the time that STA1 receives beacon frame 2121 and the DL BUs from the AP1 of AP MLD 1812.

On receiving the TIM element in beacon frame 2121 indicating DL BUs for non-AP MLD 2111 and the DL BU(s) from AP MLD 2112, non-AP MLD 1811 may change the power management mode from the first power save mode to a second power save mode. Further, non-AP MLD 2111 may start a timer 2171 (e.g., a second power save mode (PSM) timer) which value may be equal to one beacon interval. During the second power save mode, STA1, STA2, and STA3 may wake to listen for beacon frames on the enabled links at each target beacon transmission time (TBTT) on the enabled links while timer 2171 runs. In example 2100, STA2 may wake to listen for a beacon frame at a TBTT and may receive a beacon frame 2131 from AP2 of AP MLD 1812 comprising a TIM element indicating no DL BU(s) for non-AP MLD 2111.

Subsequently, AP3 of AP MLD 2112 having downlink buffered BU(s) may transmit a beacon frame 2141 comprising a TIM element indicating DL BU(s) for non-AP MLD 2111. STA3 operating in the second power save mode may wake at the TBTT and may receive beacon frame 2141. STA3 may transmit a PS-Poll frame 2142 to retrieve the DL BU(s) and may receive DL BU(s) from AP3. In example 2100, the DL BU(s) may include non-latency sensitive traffic only. AP3 may set a more data (MD) subfield in a header of an MPDU of a last buffered frame 2143 to 0 to indicate that frame 2143 is the last buffered frame for non-AP MLD 2111. On receiving frame 2143, STA3 transmits an acknowledgment frame 2144 and may return to the doze state.

In an embodiment, based on not receiving DL BU(s) with latency sensitive traffic from AP MLD 2112, non-AP MLD 2111 may not re-start timer 2171 for the second power save mode. Continuing to operate in the second power save mode, STA1 may wake at each TBTT and may receive a beacon frame 2151 from AP MLD 2112 comprising a TIM element indicating no DL BUs for non-AP MLD 2111.

When timer 2171 expires, non-AP MLD 2111 may change the power management mode from the second power save mode to the first power save mode. During the first power save mode at least one of STA1, STA2, and STA3 of non-AP MLD 2111 may wake to listen for at least one beacon frame on one of the enabled links within a listen interval of non-AP MLD 2111. Accordingly, STA2 may stay in the doze state and may not wake to listen for an upcoming beacon frame 2161 at a next TBTT.

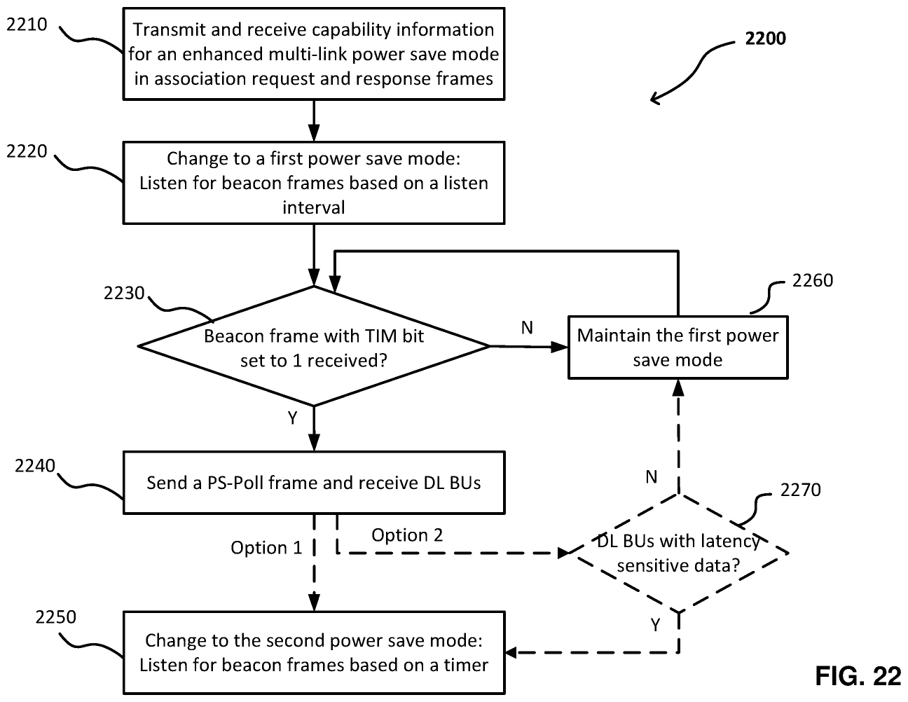

FIG. 22 illustrates an example process 2200 according to an embodiment. Example process 2200 is provided for the purpose of illustration and is not limiting of embodiments. Example process 2200 may be performed by a non-AP MLD. As shown in FIG. 22, example process 2200 includes steps 2210, 2220, 2230, 2240, 2250, 2260, and 2270.

Process 2200 may begin in step 2210, which includes transmitting and receiving to/from an AP MLD an association request frame and an association response frame including capability information for a multi-link power save mode comprising a first power save mode and a second power save mode. The capability information indicates whether the non-AP MLD and the AP MLD support the multi-link power save mode comprising the first power save mode and the second power save mode.

In step 2220, process 2200 may including changing a power management mode from an active mode to the first power save mode. In an embodiment, in the first power save mode, STAs affiliated with the non-AP MLD may wake to listen for at least one beacon frame on enabled links within a listen interval of the non-AP MLD.

In step 2230, process 2200 may include determining whether a received beacon frame indicates a TIM bit associated with the non-AP MLD set to 1. If the answer is no, process 2200 proceeds to step 2260, which includes maintaining the first power save mode. Otherwise, process 2200 transitions to step 2240.

In step 2240, process 2200 may include transmitting a PS-Poll frame and receiving one or more DL BUs from the AP MLD.

Subsequently, in a first option (Option 1), process 2200 may proceed to step 2250, which includes changing from the first power save mode to the second power save mode. During the second power mode, one or more STAs of the non-AP MLD may wake to listen for beacon frames on the enabled links at each target beacon transmission time (TBTT) on the enabled links while a timer runs. In a second option (Option 2), process 2200 may proceed to step 2270, which includes determining whether the received DL BUs contained latency-sensitive traffic. If the answer is yes, process 2200 proceeds to step 2250 described above. Otherwise, process 2200 transitions to step 2260, which includes maintaining the first power save mode.

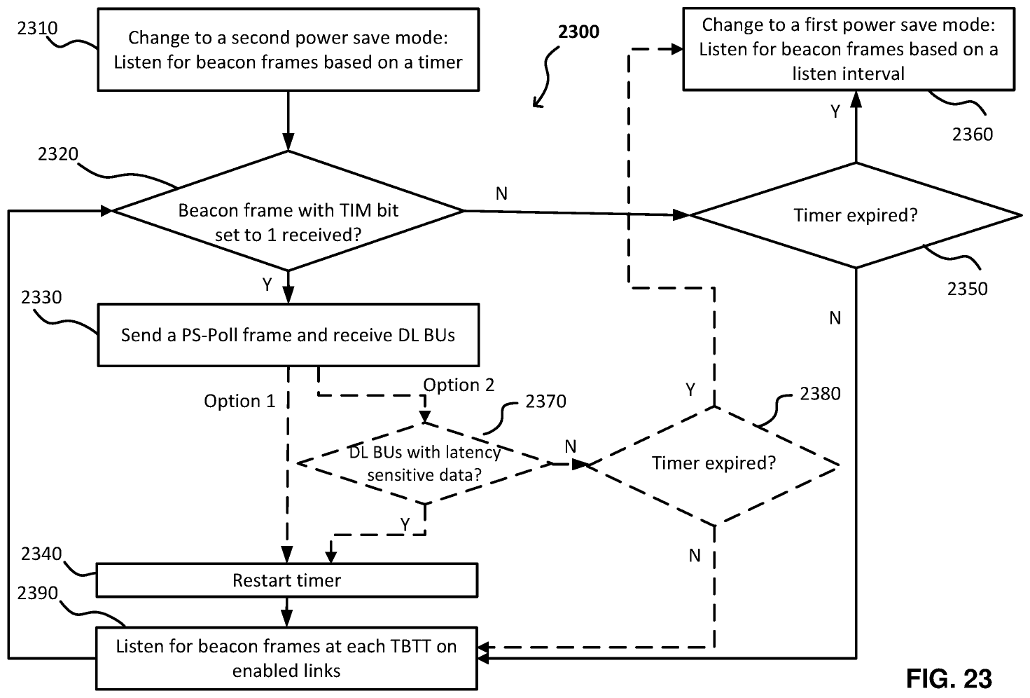

FIG. 23 illustrates an example process 2300 according to an embodiment. Example process 2300 is provided for the purpose of illustration and is not limiting of embodiments. Example process 2300 may be performed by a non-AP MLD. As shown in FIG. 23, example process 2300 includes steps 2310, 2320, 2330, 2340, 2350, 2360, 2370, 2380, and 2390.

Process 2300 may begin in step 2310, which may include changing a power management mode from a first power save mode to a second power save mode. In an embodiment, while in the second power save mode, one or more STAs of the non-AP MLD may wake from a doze state to listen for beacon frames on the enabled links at each target beacon transmission time (TBTT) on the enabled links while a timer runs.

In step 2320, process 2300 may include determining whether a received beacon frame indicates a traffic indication map (TIM) bit associated with the non-AP MLD set to 1. If the answer is no, process 2300 transitions to step 2350, which includes determining if the timer has expired. If the answer is yes, process 2300 proceeds to step 2360, which includes changing to a first power mode. In an embodiment, while in the first power save mode, STAs of the non-AP MLD may wake to listen for at least one beacon frame on enabled links within a listen interval of the non-AP MLD. If the answer in step 2350 is no, process 2300 proceeds to step 2390 further described below.

If the answer in step 2320 is yes, process 2300 proceeds to step 2330, which may include transmitting a PS-Poll frame to the AP MLD and receiving one or more DL BUs from the AP MLD. Subsequently, according to a first option (Option 1), process 2300 transitions to step 2340, which includes restarting the timer before proceeding to step 2390. In step 2390, the STAs of the non-AP MLD being in the doze state may wake to listen for beacon frames on the enabled links at each target beacon transmission time (TBTT) on the enabled links while the timer runs.

According to a second option (Option 2), process 2300 transitions to step 2370 from step 2330. In step 2370, process 2300 may include determining whether the received DL BUs comprise latency sensitive traffic. If the answer is yes, process 2300 proceeds to step 2340, which includes restarting the timer. Otherwise, process 2300 proceeds to step 2380, which includes determining whether the timer has expired. If the answer is no, process 2300 proceeds to step 2390 described above. Otherwise, process 2300 transitions to step 2360, which includes changing to the first power save mode.

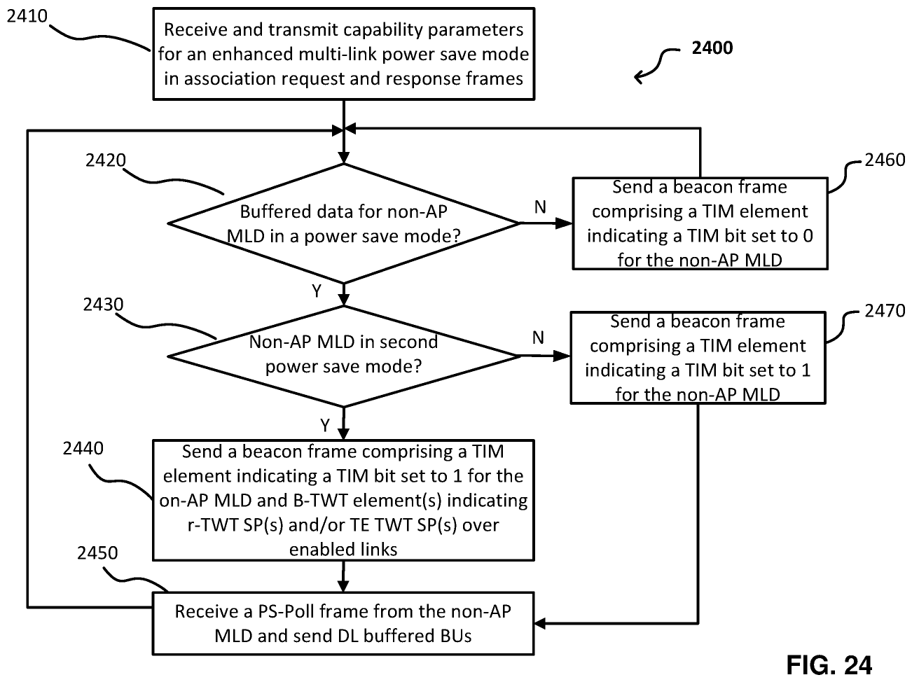

FIG. 24 illustrates an example process 2400 according to an embodiment. Example process 2400 is provided for the purpose of illustration and is not limiting of embodiments. Example process 2400 may be performed by an AP MLD. As shown in FIG. 24, example process 2400 includes steps 2410, 2420, 2430, 2440, 2450, 2460, and 2470.

Process 2400 may begin in step 2410, which includes receiving and transmitting from/to a non-AP MLD an association request frame and an association response frame including capability information for a multi-link power save mode comprising a first power save mode and a second power save mode. The capability information indicates whether the non-AP MLD and the AP MLD support the multi-link power save mode comprising the first power save mode and the second power save mode. In an embodiment, while in the first power save mode, STAs of the non-AP MLD may wake to listen for at least one beacon frame on enabled links within a listen interval of the non-AP MLD. In an embodiment, while in the second power save mode, one or more STAs of the non-AP MLD may wake from a doze state to listen for beacon frames on the enabled links at each target beacon transmission time (TBTT) on the enabled links while a timer runs.

Steps 2420-2470 may be performed with the non-AP MLD in power save mode. In step 2420, process 2400 may include determining whether the AP MLD has a downlink buffered frame for the non-AP MLD in power save mode at a target beacon transmission time (TBTT). If the answer is no, process 2400 may proceed to step 2460, which includes transmitting a beacon frame comprising a TIM element with a TIM bit set to 0 for the non-AP MLD. Otherwise, process 2400 proceeds to step 2430, which includes determining whether the non-AP MLD is in the second power save mode of the multi-link power save mode. In an embodiment, the AP MLD may determine whether the non-AP MLD is in the second power save mode based on a timer associated with the second power save mode at the non-AP MLD.

If the answer in step 2430 is no, process 2400 proceeds to step 2470, which includes transmitting a beacon frame comprising a TIM element with a TIM bit set to 1 for the non-AP MLD. Process 2400 may then proceed to step 2450 described further below. Otherwise, process 2400 proceeds to step 2440, which includes transmitting a beacon frame comprising a TIM element with a TIM bit set to 1 for the non-AP MLD and one or more broadcast target wake time (TWT) element(s) indicating an r-TWT SP and/or a TE TWT SP over the enabled links. The r-TWT SP and/or a TE TWT SP may be scheduled to provide an uplink dedicated resource for uplink transmission from the non-AP MLD. Process 2400 may then proceed to step 2450, which may include receiving a PS-Poll frame from the non-AP MLD and transmitting at least one DL buffered BU to the non-AP MLD.

1. A non-access point multi-link device (non-AP MLD) comprising:
one or more processors; and
memory storing instructions that, when executed by the one or more processors, cause the non-AP MLD to:
receive, from an access point multi-link device (AP MLD), while in a first power save mode, a beacon frame comprising a traffic indication map (TIM) element indicating downlink buffered units (BUs) for the non-AP MLD, wherein during the first power save mode the non-AP MLD wakes to listen for beacon frames on one of enabled links at least once within a listen interval; and
after receiving the downlink BUs from the AP MLD, switch to a second power save mode, wherein during the second power save mode the non-AP MLD wakes to listen for beacon frames at each target beacon transmission time (TBTT) on the enabled links until a timer expires.

2. The non-AP MLD of claim 1, wherein the instructions, when executed by the one or more processors, further cause the non-AP MLD to:
transmit a frame to the AP MLD to retrieve the downlink BUs; and
receive the downlink BUs from the AP MLD.

3. The non-AP MLD of claim 2, wherein the frame to retrieve the downlink BUs is a power save poll frame or a trigger frame.

4. The non-AP MLD of claim 1, wherein the instructions, when executed by the one or more processors, further cause the non-AP MLD to switch from an active mode to the first power save mode.

5. The non-AP MLD of claim 4, wherein the instructions, when executed by the one or more processors, further cause the non-AP MLD to transmit a frame comprising a power management (PM) subfield indicating the switching from the active mode to the first power save mode.

6. The non-AP MLD of claim 1, wherein the instructions, when executed by the one or more processors, cause the non-AP MLD to switch to the second power save mode in response to receiving the downlink BUs from the AP MLD.

7. The non-AP MLD of claim 6, wherein the instructions, when executed by the one or more processors, cause the non-AP MLD to switch to the second power save mode in response to the downlink BUs comprising at least one latency sensitive BU.

8. An access point multi-link device (AP MLD) comprising:
one or more processors; and
memory storing instructions that, when executed by the one or more processors, cause the AP MLD to:
determine:
that a non-access point multi-link device (non-AP MLD) is in a first power save mode, wherein during the first power save mode the non-AP MLD wakes to listen for beacon frames at each target beacon transmission time (TBTT) on enabled links until a timer expires; and
presence of downlink (DL) bufferable units (BUs) for the non-AP MLD while the non-AP MLD in the first power save mode;
transmitting a beacon frame comprising a Traffic Indication Map (TIM) element indicating the DL BUs for the non-AP MLD and a target wake time (TWT) service period (SP) for the non-AP MLD; and
transmitting the DL BUs during the TWT SP.

9. The AP MLD of claim 8, wherein the instructions, when executed by the one or more processors, further cause the AP MLD to receive a frame from the non-AP MLD, during the TWT SP, to retrieve the downlink BUs.

10. The AP MLD of claim 9, wherein the frame to retrieve the downlink BUs is a power save poll frame or a trigger frame.

11. The AP MLD of claim 8, wherein the instructions, when executed by the one or more processors, further cause the AP MLD to receive, from the non-AP MLD, a frame comprising a power management (PM) subfield indicating a switch by the non-AP MLD from an active mode to a second power save mode.

12. The AP MLD of claim 11, wherein during the second power save mode the non-AP MLD wakes to listen for beacon frames on one of the enabled links at least once within a listen interval.

13. The AP MLD of claim 8, wherein the instructions, when executed by the one or more processors, further cause the AP MLD to transmit a beacon frame comprising a TIM element comprising a TIM bit associated with the non-AP MLD set to 0, based on determining absence of DL BUs for the non-AP MLD.

14. The AP MLD of claim 8, wherein the instructions, when executed by the one or more processors, further cause the AP MLD to transmit a beacon frame comprising a TIM element comprising a TIM bit associated with the non-AP MLD set to 1, based on determining presence of DL BUs for the non-AP MLD and that the non-AP MLD is in the first power save mode.

15. A non-transitory computer-readable medium comprising instructions that, when executed by one or more processors of a non-access point multi-link device (non-AP MLD), cause the non-AP MLD to:
receive, from an access point multi-link device (AP MLD), while in a first power save mode, a beacon frame comprising a traffic indication map (TIM) element indicating downlink buffered units (BUs) for the non-AP MLD, wherein during the first power save mode the non-AP MLD wakes to listen for beacon frames on one of enabled links at least once within a listen interval; and
after receiving the downlink BUs from the AP MLD, switch to a second power save mode, wherein during the second power save mode the non-AP MLD wakes to listen for beacon frames at each target beacon transmission time (TBTT) on the enabled links until a timer expires.

16. The non-transitory computer-readable medium of claim 15, wherein the instructions, when executed by the one or more processors, further cause the non-AP MLD to:
transmit a frame to the AP MLD to retrieve the downlink BUs; and
receive the downlink BUs from the AP MLD.

17. The non-transitory computer-readable medium of claim 16, wherein the frame to retrieve the downlink BUs is a power save poll frame or a trigger frame.

18. The non-transitory computer-readable medium of claim 15, wherein the instructions, when executed by the one or more processors, further cause the non-AP MLD to switch from an active mode to the first power save mode.

19. The non-transitory computer-readable medium of claim 18, wherein the instructions, when executed by the one or more processors, further cause the non-AP MLD to transmit a frame comprising a power management (PM) subfield indicating the switching from the active mode to the first power save mode.

20. The non-transitory computer-readable medium of claim 15, wherein the instructions, when executed by the one or more processors, cause the non-AP MLD to switch to the second power save mode in response to the downlink BUs comprising at least one latency sensitive BU.
